(19) United States
(12) Patent Application Publication
(10) Pub. No.: US 2006/0184383 A1
(43) Pub. Date: Aug. 17, 2006

(54) Methods and systems for pricing parts and components

(75) Inventors: Rick Davis, Tomball, TX (US); Sam Loughlin, Tomball, TX (US)

Correspondence Address: CONLEY ROSE, P.C., P. O. BOX 3267, HOUSTON, TX, 77253-3267, US

(73) Assignee: Domestic Auto Experts, Tomball, TX (US)

(21) Appl. No.: 11/353,261

(22) Filed: Feb. 14, 2006

Related U.S. Application Data
(60) Provisional application No. 60/652,828, filed on Feb. 14, 2005.
(60) Provisional application No. 60/652,753, filed on Feb. 14, 2005.

(51) Int. Cl. G06Q 99/00

(52) U.S. Cl. 705/1

(57) ABSTRACT

A method and system for sourcing a part is provided. The method comprises specifying a generic part description for a part. In addition, the method comprises mapping the generic part description to one or more specific part descriptions across a plurality of vendors. Further the method comprises generating a list of the one or more specific part descriptions.

### CROSS-REFERENCE TO RELATED APPLICATIONS

This non-provisional application claims the benefit of U.S. Provisional Application No. 60/652,828, filed Feb. 14, 2005, and U.S. Provisional Application No. 60/652,753, filed Feb. 14, 2005, which are each hereby incorporated herein by reference in their entirety.

### STATEMENT REGARDING FEDERALLY SPONSORED RESEARCH OR DEVELOPMENT

Not applicable.

### BACKGROUND OF THE INVENTION

1. Field of the Invention

The present disclosure is directed to methods and systems for sourcing and procuring parts and pricing repairs, and more particularly, but not by way of limitation, to methods and systems for sourcing parts, and pricing parts, labor, diagnostics, and hazmat fees associated with vehicle repairs.

2. Background of the Invention

As of 2005, there were about 220 million automobiles in the United States, or about 0.75 automobiles per person. Generally, the maintenance and repair of vehicles is performed by repair and service centers.

The processes of sourcing parts for repairs, procuring parts for repairs, and pricing repairs play a large role in the infrastructure of a service center's business. For example, to generate a repair order for a customer (e.g., repair estimate, repair invoice, etc.), a service center may price each individual cost associated with a repair, and then sum these costs to arrive at a total price for the repair. The costs that may be associated with repairs include parts costs, labor costs, diagnostic costs, hazmat costs, travel costs, etc. Further, these costs may be impacted by the sourcing and procurement of the individual parts required to perform the repair (e.g., shipping costs).

In some service centers, the processes of sourcing parts, procuring parts, and pricing repairs may be a completely manual and a potentially time consuming process. The process may require gathering information from the customer (e.g., vehicle symptoms, vehicle year/make/model, vehicle identification number, etc.), gathering information from parts vendors (e.g., identifying which vendors carry needed parts, obtaining prices for the parts from numerous vendors, checking the availability of each part, etc.), estimating labor time and effort necessary to complete the repair (e.g., number of technician or mechanic hours, etc.), estimating certain costs that may be difficult to quantify (e.g., disposal fees, potential overruns, etc.), calculating taxes, calculating the total repair price, etc. For instance, some conventional methods for sourcing each part necessary to complete a repair may require placing phone calls to individual vendors, stating the required part description, waiting while the vendor researches and locates the part and then documenting cost and availability. That process may need to be duplicated for every vendor in order to determine competitive pricing and availability. Also, some vendors may only relay one part manufacturer rather than disclosing other options. Even when the sourcing of parts is done electronically via the internet, the sourcing may be done sequentially from one vendor to another and the process is duplicated for each vendor.

Further, some conventional approaches to price repairs may reduce the ability of the service provider to separately control and target parts pricing, labor pricing, diagnostic pricing, hazmat pricing, etc. By limiting the ability of the service center to control and target prices, the revenues of the service center may be affected. Still further, other conventional approaches to price repairs may leave pricing discretion at the mechanic or technician level, which may result in pricing disparities across different customers and across different service centers within the same company.

Consequently, there is a need for improved part sourcing and repair pricing methods and systems. In addition, there is a need for repair pricing methods and systems that provide consistent results. Further needs include repair pricing methods and systems that can be controlled at a unit level (e.g., part or customer level) and adjusted periodically to maximize revenues for the service provider.

### BRIEF SUMMARY OF SOME OF THE PREFERRED EMBODIMENTS

These and other needs in the art are addressed in one embodiment by a method for sourcing a part. In an embodiment, the method comprises specifying a generic part description for a part. In addition, the method comprises mapping the generic part description to one or more specific part descriptions across a plurality of vendors. Further, the method comprises generating a list of the one or more specific part descriptions.

These and other needs in the art are addressed in another embodiment by a method. In an embodiment, the method comprises generating a list of one or more specific part descriptions. In addition, the method comprises filtering the one or more specific part descriptions to generate a revised specific part list, wherein the step of filtering determines whether to exclude one or more specific part descriptions based on one or more specified criteria. Further, the method comprises selecting a desired part from the one or more specific part descriptions on the revised specific part list.

These and other needs in the art are addressed in another embodiment by a method for pricing a part. In an embodiment, the method comprises generating a list of one or more specific part descriptions, determining a list price for each specific part description, and determining a highest list price for the one or more specific part descriptions. In addition, the method comprises selecting a desired part from the one or more specific part descriptions and identifying the desired part list price. Further, the method comprises applying a part pricing matrix to the highest list price to determine a base part invoice price. Still further, the method comprises determining a part invoice price for the desired part by comparing the base part invoice price to a maximum part price, wherein the maximum part price is a multiple of the desired part list price, wherein if the base part invoice price is greater than the maximum part price, then the part invoice price equals the maximum part price, and wherein if the base part invoice price is less than or equal to the maximum part price, then the part invoice price equals the base part invoice price.

These and other needs in the art are addressed in another embodiment by a method for sourcing and pricing a part. In an embodiment, the method comprises specifying a generic part description for a part and mapping the generic part description to one or more specific part descriptions, wherein each of the one or more specific part descriptions has a list price. In addition, the method comprises selecting a desired part from the one or more specific part descriptions and identifying the list price for the desired part from the one or more specific part descriptions. Further, the method comprises identifying the highest list price from the one or more specific part descriptions and applying a part pricing matrix to the highest list price to calculate a base part invoice price. Still further, the method comprises determining a part invoice price by comparing whether the base part invoice price is greater than a maximum part price, wherein the maximum part price is a multiple of the desired part list price, wherein if the base part invoice price is greater than the maximum part price, then the part invoice price equals the maximum part price, and wherein if the base part invoice price is less than or equal to the maximum part price, then the part invoice price equals the base part invoice price.

These and other needs in the art are addressed in another embodiment by a method for sourcing a part. In an embodiment, the method comprises specifying a generic part description for a part. In addition, the method comprises mapping the generic part description to one or more specific part descriptions across one or more vendors. Further, the method comprises generating a list of the one or more specific part descriptions.

These and other needs in the art are addressed in another embodiment by a parts sourcing apparatus. In an embodiment, the apparatus comprises a display. In addition, the apparatus comprises a user input device. Further, the apparatus comprises a memory that stores software. Still further, the apparatus comprises a processor coupled to the memory to execute the software, wherein the software configures the processor to interact with a user via the display and user input device, and wherein the software further configures the processor to allow the user to specify a generic part description, map the generic part description to one or more specific part descriptions across a plurality of vendors, generate a list of the one or more specific part descriptions, display the list of the one or more specific part descriptions on the display, and allow the user to specify a desired part from the list of the one or more specific part descriptions.

These and other needs in the art are addressed in another embodiment by an apparatus to price a part. In an embodiment, the apparatus comprises a display. In addition, the apparatus comprises a user input device. Further, the apparatus comprises a memory that stores software. Still further, the apparatus comprises a processor coupled to the memory to execute the software, wherein the software configures the processor to interact with a user via the display and user input device, and wherein the software further configures the processor to generate a list of the one or more specific part descriptions, apply a filter to the list of the one or more specific part descriptions to generate a revised specific part list, wherein the filter determines whether to exclude one or more specific part descriptions based on one or more specified criteria, display the revised specific part list on the display, allow the user to specify a desired part from the revised specific part list; and determine a part invoice price for the desired part.

Theses and other needs in the art are addressed in another embodiment by an information carrier medium. In an embodiment, the information carrier medium communicates software to a computer, wherein the software when executed effects a part sourcing method that comprises specifying a generic part description for a part, mapping the generic part description to one or more specific part descriptions across a plurality of vendors, and generating a list of the one or more specific part descriptions.

Theses and other needs in the art are addressed in another embodiment by an information carrier medium. In an embodiment, the information carrier medium communicates software to a computer, wherein the software when executed effects a part pricing method that comprises generating a list of one or more specific part descriptions, filtering the one or more specific part descriptions to generate a revised specific part list, wherein the step of filtering determines whether to exclude one or more specific part descriptions based on one or more specified criteria, selecting a desired part from the one or more specific part descriptions on the revised specific part list, and determining a part invoice price for the desired part.

The foregoing has outlined rather broadly the features and advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other methods or systems for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts, blocks, processes, or steps.

FIG. 1 shows an illustrative service center and repair order;

FIG. 2 shows an illustrative system for operating a service center;

FIG. 3 shows an illustrative logic flow diagram of a process for pricing repairs according to an embodiment of the disclosure;

FIG. 4 shows a graphical illustration of a symptom tree that may be used in the process for pricing diagnostics shown in FIG. 5;

FIG. 5 shows an illustrative logic flow diagram of a process for pricing diagnostics according to an embodiment of the disclosure;

FIG. 6 shows an illustrative logic flow diagram of a process for sourcing and procuring parts according to an embodiment of the disclosure;

FIG. 7 shows an illustrative logic flow diagram of a process for pricing parts according to an embodiment of the disclosure;

FIG. 8 shows an illustrative logic flow diagram of a process for pricing labor according to an embodiment of the disclosure;

FIG. 9 shows an illustrative logic flow diagram of a process for pricing hazmat fees according to an embodiment of the disclosure;

FIG. 10 shows an illustrative system for sourcing and procuring parts, and pricing repairs embodied as a desktop computer; and

FIG. 11 shows an illustrative block diagram of a system for sourcing and procuring parts, and pricing repairs.

### TERMINOLOGY

In the following discussion and in the claims, the terms “including” and “comprising” are used in an open-ended fashion, and thus should be interpreted to mean “including, but not limited to . . . ”.

The term “couple” or “couples” is intended to mean either an indirect or direct electrical connection. Thus, if a first device couples to a second device, that connection may be through a direct electrical connection, or through an indirect electrical connection via other devices and connections.

The terms “communication,” “in communication,” “communicates,” or “communicating” is intended to mean either an indirect or direct connection for transmitting data or information between two processes, devices, blocks, etc. Thus, if a first device communicates with a second device, that transmission of data or information between the first device and the second device may be through a direct connection, or through an indirect connection via other devices, processes, or connections. The indirect or direct connection may be an electrical connection.

The term “cost” is intended to mean the price incurred for a good or service provided by a vendor. For example, if a parts vendor sells a part to a service center, the cost of the part is the price the vendor charges the service center for the part.

The term “list price” is intended to mean the general price the market will bear. For example, the list price of a good may be the manufacturer's suggested retail price for the good or the price a vendor would charge an individual off the street for the good.

The term “invoice price” is intended to mean the price incurred by a customer. For example, if a service center acquires a part from a vendor to perform repairs on a customer's vehicle, the invoice price of the part is the price the service center charges the customer for the part.

The term “map” or “mapping” refers to a process of associating items such as part descriptions, labor descriptions, manufacturers, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A. Overview

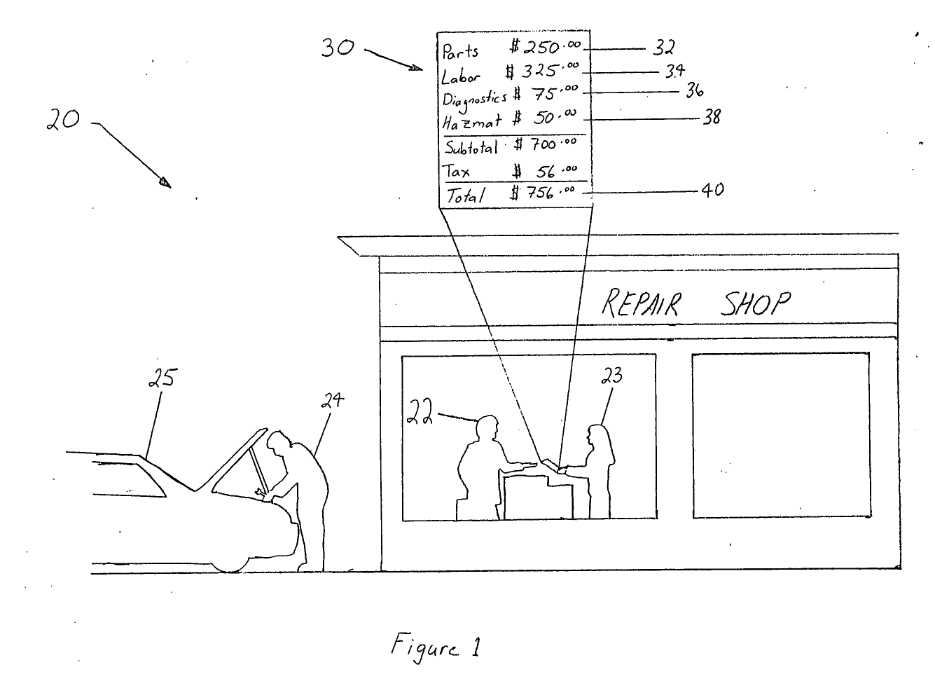

FIG. 1 shows a representative service center 20 in which a customer 22 has brought a vehicle 25 for diagnosis and repair. Based on identified symptoms (not illustrated), a technician 24 may diagnose and/or perform repairs on vehicle 25. A symptom may be any irregularity that may indicate a possible problem with vehicle 25, including without limitation visual signs, audible signs, tactile signs, or combinations thereof. For instance, a squeaking sound while applying the brakes of an automobile is a symptom (e.g., audible sign) of a potential brake problem. In addition, a symptom may be identified by any suitable means, including without limitation identified by customer 22, identified by a manager 23, identified by technician 24 or combinations thereof.

Service center 20 shown in FIG. 1 is a vehicle service center, however, in other embodiments (not illustrated), service center 20 may be any other business that diagnoses, or services/repairs goods, including without limitation home appliance service centers, electronics service centers, etc. Similarly, vehicle 25 may be any good or product in need of diagnosis, repair, maintenance, or servicing, including without limitation a home appliance (e.g., washing machine), electronic equipment (e.g., computer), a sporting good (e.g., ski binding), a mechanical device (e.g., law mower), etc.

FIG. 1 shows customer 22 receiving a repair order 30 from manager 23. Repair order 30 may be a repair estimate given to customer 22 before any repairs are performed, or an invoice given to customer 22 after a repair has been performed. For example, customer 22 may have experienced some problems with vehicle 25 (e.g., irregular noise, breakdown, etc.) and thereafter dropped vehicle 25 at service center 20 for diagnosis. However, before agreeing to have vehicle 25 repaired, customer 22 may request an estimate (e.g., repair order 30). Once customer 22 obtains the estimate, customer 22 can decide whether to have the repairs performed by service center 20. In another example, repair order 30 may be an invoice for actual repairs already performed. In this case, repair order 30 represents the charges customer 22 is expected to pay for the services rendered by service center 20 to repair vehicle 25.

Repair order 30 comprises a total parts price 32, a total labor price 34, a total diagnostics price 36, a total hazmat price 38, and a total customer price 40. In different embodiments, repair order 30 may include other fees. Further, in some embodiments, repair order 30 may comprise additional information, including without limitation information uniquely identifying vehicle 25 (e.g., vehicle year/make/model, vehicle identification number, etc.), customer 22 contact information, service center 20 contact information, scheduling information, or combinations thereof.

Total parts price 32 may comprise the total price that customer 22 may be charged for parts necessary to repair vehicle 25. Total parts price 32 may include without limitation, the cost to service center 20 for parts necessary to perform the repair, shipping costs associated with the parts, mark-ups, discounts, or combinations thereof.

Total labor price 34 may comprise the total price that customer 22 may be charged for labor necessary to repair vehicle 25. Total labor price 34 may include without limitation, the labor cost of technician 24 associated with the repair of vehicle 25, the labor cost of any specialists associated with the repair of vehicle 25, the labor costs of manager 23 associated with the repair of vehicle 25, any incidental labor costs due to unexpected problems in repairing vehicle 25, mark-ups, discounts, or combinations thereof.

Total diagnostic price 36 may comprise the total price that customer 22 may be charged for diagnostics necessary to diagnose the symptoms exhibited by vehicle 25. Total diagnostic price 36 may include without limitation, a flat fee for diagnosis, a fee associated with each symptom, a fee associated with technical equipment necessary to perform the diagnosis, or combinations thereof.

Total hazmat price 38 may comprise the total price that customer 22 may be charged for hazmat costs attributed to the repair of vehicle 25. Total hazmat price 38 may include without limitation, disposal fees (e.g., used oil disposal fees), recycling fees (e.g., radiator coolant recycling fee), core fees to be recredited at a later time (e.g., battery core fee), a flat hazmat fee, a hazmat fee based on a percentage of total parts price 32 and total labor price 34, miscellaneous shop fees, mark-ups, discounts, or combinations thereof.

Total hazmat price 38 may include fees not directly associated with the repair of vehicle 25, but which may be shared by each customer 22 of service center 20. For example, service center 20 may have a used oil drum that stores used oil taken from hundreds of serviced vehicles. Periodically, service center 20 may dispose of this used oil, thereby incurring a disposal fee. Although service center 20 may not know exactly what portion of the used oil came from each customer 22, service center 20 may apply a flat fee (e.g., $2) to each customer 22 who gets an oil change. The flat fee may help service center 20 account for the disposal fee(s) that will eventually be incurred to dispose of the used oil.

Total customer price 40 may comprise the bottom line price that customer 22 may be charged for the repair of vehicle 25. In the embodiment shown in FIG. 1, total customer price 40 is the sum of total parts price 32, total labor price 34, total diagnostic price 36, total hazmat price 38, and any taxes. In different embodiments, total customer price 40 may include without limitation additional costs, different costs, or combinations thereof. For instance, in an embodiment (not illustrated), total customer price 40 does not include total hazmat price 18. In addition, in some embodiments, certain costs may be rolled into other costs to minimize the information visible on repair order 30. For example, in an embodiment (not illustrated), total hazmat price 38 is not listed as a line item on repair order 30, but is instead rolled into total parts price 32. Further, the sequence of the line items on repair order 30 may vary.

Still referring to FIG. 1, manager 23 may be responsible for the day-to-day management and operation of service center 20. For instance, manager 23 may define the labor rates, preferred vendors, surcharges, mark-ups, discounts, fees, or any other parameter that affects the operation or revenues of service center 20. In addition, manager 23 may be the primary point of contact for customer 22. Further, manager 23 may define the presentation and organization of the information that appears on repair order 30.

Technician 24 may be a mechanic, a specialist, or any person that diagnoses vehicle 25, performs services on vehicle 25, performs repairs on vehicle 25, or combinations thereof. Technician 24 may have some discretion as to specific parts selected to perform the repair and the particular method of repairing vehicle 25.

B. Service Center System

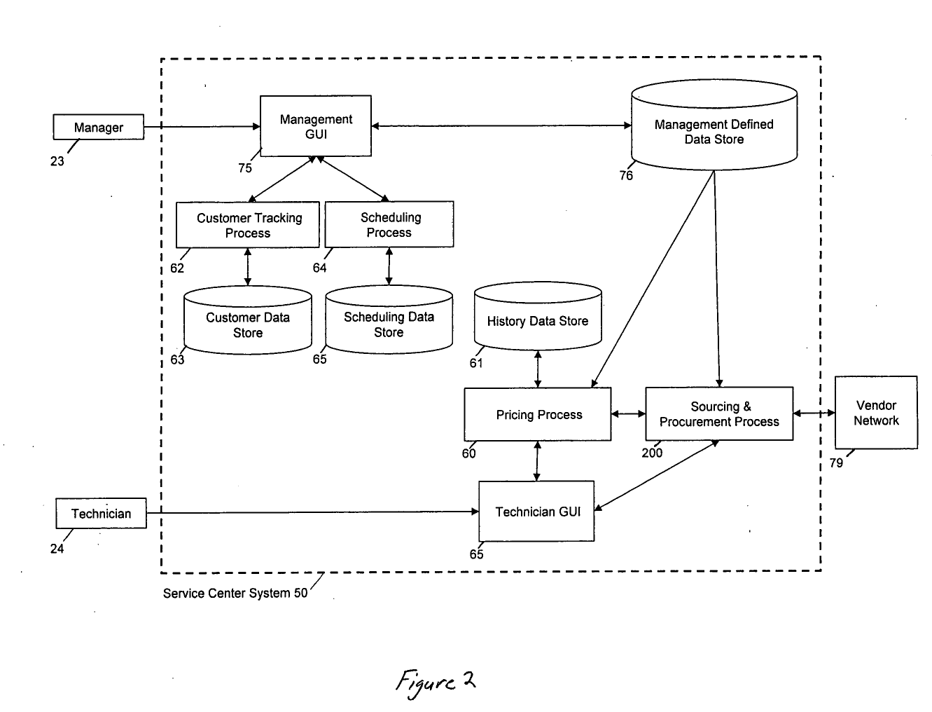

FIG. 2 shows an illustrative service center system 50 that may be employed to operate service center 20. Service center system 50 comprises a customer tracking process 62, a scheduling process 64, a pricing process 60, and a sourcing and procurement process 200. Customer tracking process 62 may be in communication with a customer data store 63, scheduling process 64 may be in communication with a scheduling data store 65, pricing process 60 may be in communication with a history data store 61, and sourcing and procurement process 200 may be in communication with history data store 61 via pricing process 60. In addition, a management defined data store 76 may be in communication with pricing process 60 and sourcing and procurement process 200. Still further, sourcing and procurement process 200 may be in communication with a vendor network 79.

In select embodiments, service center system 50 may be implemented via software running on a general purpose computer system. General purpose computer systems are discussed in detail below. In other embodiments, the individual processes of service center system 50 (e.g., customer tracking process 62, scheduling process 64, pricing process 60, sourcing and procurement process 200, etc.) may be performed manually, partially automated by software, or fully automated by software. For example, scheduling process 64 may be performed manually (e.g., implemented without the use of software running on a computer system), whereas pricing process 60 may be fully automated by software run on a computer system.

The embodiment illustrated in FIG. 2 shows several data stores (e.g., management defined data store 76, customer data store 63, history data store 61, etc.). In general, a data store may comprise any suitable means of storing data or information, including without limitation a paper document, a table, a list, a database, a file, a hard drive, a computer disk, a CD-ROM, or combinations thereof. Without limitation, the data and/or information stored in a data store may be accessed, retrieved, manipulated, mined, queried, transferred, copied, or combinations thereof. In select embodiments, customer data store 63, scheduling data store 65, history data store 61, management defined data store 76, or combinations thereof may comprise databases stored in memory within a computer system, and accessed and managed by software running on the computer system. For example, without limitation, such software may be used to access the data, manipulate the data, add to the data, delete from the data, etc. stored in each data store (e.g., customer data store 63, scheduling data store 65, history data store 61, management defined data store 76, etc.). Still further, the data and information stored in customer data store 63, scheduling data store 65, history data store 61, management defined data store 76, or combinations thereof may be used to generate reports, including without limitation, customer scheduling reports, financial reports, vendor reports, etc.

In some embodiments, a single data store (e.g., history data store 61) may be shared by more than one process (e.g., pricing process 60 and sourcing and procurement process 200). However, in different embodiments, each process of service center system 50 may have its own dedicated data store.

Technician 24 may access and communicate with service center system 50 through a technician graphical user interface (GUI) 65. For example, technician 24 may input data into service center system 50, preview data within service center system 50, query data within service center system 50, and retrieve data from service center system 50 through technician GUI 65. As shown in FIG. 2, technician 24 may have access to pricing process 60, sourcing and procurement process 200, and associated history data store 61. In addition, technician 24 may have access to a vendor network 79 through sourcing and procurement process 200. In different embodiments, technician 24 may have access to additional, different, and/or fewer processes and data stores.

Service manager 23 may access and communicate with service center system 50 through the management graphical user interface (GUI) 75. For example, service manager 23 may input data into service center system 50, preview data within service center system 50, query data within service center system 50, manipulate data within service center system 50, and retrieve data from the service center system 50 through management GUI 75. As shown in FIG. 2, service manager 23 has access to customer tracking process 62, scheduling process 64, and associated customer data store 63 and scheduling data store 65, respectively. In addition, manager 23 may access management defined data store 76. In the embodiment shown in FIG. 2, only manager 23 may access management defined data store 76. In other embodiments, manager 23 may have direct access to other processes and data stores. Manager 23 may also gain access to pricing process 60, procurement process 70, history data store 61, and vendor network 79 by accessing service center system 50 through technician GUI 65 (e.g., service manager 23 may log onto service center system 50 as a technician).

Management defined data store 76 may store any suitable management defined data or information including without limitation, business rules for service center 20 (e.g., set minimums or maximums for fees, etc.), pricing parameters (e.g., labor rates, mark-up percentages, etc.), permitted or excluded vendors (e.g., service center 20 may procure any part from vendor A, but may only procure brake pads from vendor B, etc.), permitted or excluded brands (e.g., service center may procure “Brand J” brake pads, but not “Brand K” brake pads, etc.) or combinations thereof. Since management defined data store 76 contains data that may directly impact total parts price 32, total labor price 34, total diagnostics price 36, total hazmat price 38, total customer price 40, and hence effect the financial performance of service center 20, management defined data store 76 may be controlled exclusively at the manager level (i.e., technician 24 does not have access to the management defined data store 76).

Still referring to FIG. 2, customer tracking process 62 may be used to gather, manage, and track customer data. Customer data may include without limitation, customer contact information (e.g., address, phone, e-mail, etc.), customer billing information (e.g. credit accounts, billing address, etc.), specific information about a customer's vehicle (e.g., year/make/model, VIN, etc.), repair history information (e.g., past problems, past repairs, etc.), or combinations thereof. Customer data store 63 may store the customer data. For example, when a first-time customer 22 arrives at service center 20, manager 23 may gather new customer information as part of customer tracking process 62 and store this information in customer data store 63. The customer information stored in customer data store 63 may be accessed, queried, retrieved, manipulated etc. at a later time.

Scheduling process 64 may be used to setup and manage customer appointments for services and repairs. Scheduling data store 65 may store scheduling data. Scheduling data may include without limitation, the date and time of service appointments, the type of service scheduled (e.g., oil change, brake job, etc.), the date and time that repairs are complete, the priority of the scheduled service (e.g., low priority, medium priority, high priority, etc.), or combinations thereof. For example, when customer 22 contacts service center 20 and requests to drop off vehicle 25 for repairs, manager 23 may first gather and store customer data as part of the customer tracking process 62, and then schedule an appointment for customer 22 as part of scheduling process 64. The scheduling data stored in scheduling data store 64 may be accessed, queried, retrieved, manipulated, etc. at a later time.

Sourcing and procurement process 200 may be used to source and procure items necessary to perform repairs on vehicle 25. Examples of items necessary to perform repairs on a vehicle 25 include without limitation, parts, equipment, independent contractors, services, or combinations thereof. In an embodiment, history data store 61 may store sourcing and procurement data used in sourcing and procurement process 200. Sourcing and procurement data may include without limitation, vendors, part descriptions, part list prices, part costs, historical performance of vendors, preferred vendors, vendor catalogs, or combinations thereof.

In addition, sourcing and procurement process 200 may communicate with a vendor network 79. Vendor network 79 may include one or more vendors. In general a vendor may be any person or entity that supplies goods or services. In particular, regarding parts, vendors may include without limitation, part retailers, part wholesalers, part suppliers, part manufacturers, etc.

Vendor network 79 may provide information including without limitation, vendor catalogs, part descriptions, specific part availability, specific part numbers, specific part stock keeping units (SKUs), specific part list prices, specific part costs, vendor location, shipping costs for specific parts, estimated arrival date for specific parts, or combinations thereof. For example, vendor network 79 may include electronic catalogs of one or more vendors that display each vendor's inventory of parts. Further, the data provided by vendor network 79 (e.g., part price, shipping costs, etc.) may be communicated to pricing process 70 via the sourcing and procurement process 200. However, in some embodiments, pricing process 60 may directly communicate with vendor network 79, thereby bypassing sourcing and procurement process 200.

In addition, management defined data store 76 may provide certain management defined data information to sourcing and procurement process 200. For example, in management defined data base 76, manager 23 may setup rules permitting parts ordering from certain vendors and disallowing parts ordering from other vendors (e.g., headlights can be procured from “Vendor E”, but not from “Vendor F”). In this example, when technician 24 attempts to procure a headlight via sourcing and procurement process 200, technician 24 may be permitted to order the headlight from “Vendor E”, but may not permitted to order the headlight from “Vendor F”.

Pricing process 60 may be used to price repairs to be performed on vehicle 25 and/or repairs already performed on vehicle 25 (e.g., total customer price 40). History data store 61 may store any suitable pricing data used by pricing process 60, including without limitation generic part descriptions, specific part descriptions, part list prices, part costs, or combinations thereof. The data stored in history data store 61 may be accessed, queried, retrieved, manipulated, updated, etc.

Since pricing process 60 may require some sourcing and procurement data (e.g., part list price, part cost, part availability, etc.), pricing process 60 and sourcing and procurement process 200 may be in communication with each other. For example, to determine total customer price 40, pricing process 60 may require the cost and list price of parts procured to repair vehicle 25. In this example, the cost and list price of the parts may be provided to pricing process 60 by sourcing and procurement process 200. In some embodiments (not illustrated), live data (e.g., real time) associated with specific parts (e.g., current list price, current cost, current availability, etc.) may be stored in a data store that may be accessed by pricing process 60 and sourcing and procurement process 200.

In addition, management defined data store 76 may provide certain management defined data to pricing process 60. For example, in management defined data store 76, manager 23 may define a flat mark-up (e.g., 10% mark-up) on all parts procured for repairs. In this example, if part cost is $100 (e.g., cost of the part to service center 20), the invoice price may be $110 (e.g., price charged customer 22 for the part).

In other embodiments, service center system 50 may include without limitation, additional processes, fewer processes, additional data stores, or combinations thereof. In addition, the arrangement of the processes, sub-processes, steps, and data stores of service center system 50 may be varied in certain embodiments. For example, communication between the various processes and data stores may be varied. In other embodiments, the processes and/or data stores may be in communication with any other suitable system internal or external to service center system 50. Examples of such systems include without limitation, backoffice systems, report generating systems, management systems, service analysis systems, or combinations thereof.

C. Pricing Process

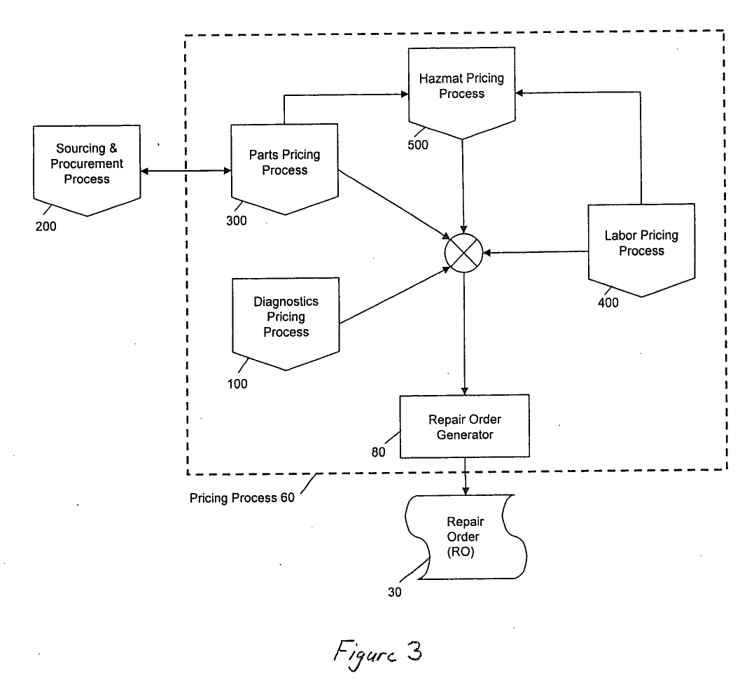

FIG. 3 shows an embodiment of pricing process 60. Pricing process 60 comprises a diagnostics pricing process 100, a parts pricing process 300, a labor pricing process 400, a hazmat pricing process 500, and a repair order generator 80. Repair order generator 80 may generate repair order 30. Sourcing and procurement process 200 may communicate with parts pricing process 300.

Referring to FIGS. 1 and 3, diagnostics pricing process 100 may generate total diagnostics price 36, parts pricing process 300 may generate total parts price 32, labor pricing process 400 may generate total labor price 34, and hazmat pricing process 500 may generate total hazmat price 38. In the embodiment shown in FIG. 3, parts pricing process 300 and labor pricing process 400 may provide total parts price 32 and total labor price 34, respectively, to hazmat pricing process 300. For example, hazmat pricing process 500 may use total parts price 32 and total labor price 34 to generate total hazmat price 38. In different embodiments, communication between the various processes of pricing process 60 (e.g., diagnostics pricing process 100, parts pricing process 300, labor pricing process 400, hazmat pricing process 500, etc.) may be arranged differently. For example, diagnostics pricing process 100 may communicate with hazmat pricing process 500.

In addition, the results of parts pricing process 300, labor pricing process 400, hazmat pricing process 500, and diagnostic pricing process 100 (e.g., total parts price 32, total labor price 34, total diagnostics price 36, and total hazmat price 38, respectively) may be summed to determine total customer price 40 and/or may be communicated to repair order generator 80. The total parts price 32, total labor price 34, total diagnostics price 36, total hazmat price 38, and total customer price 40 may be used by repair order generator 80 to create repair order 30. Repair order 30 may be an estimate or invoice. Further, repair order 30 may be displayed in any suitable manner including without limitation, on a computer display, on a printout, or combinations thereof.

Sourcing and procurement process 200 may communicate with parts pricing process 300. Sourcing and procurement process 200 may provide without limitation, specific part costs, specific part list prices, generic part descriptions, specific part descriptions, specific part availability, or combinations thereof to parts pricing process 300. For example, parts pricing process 300 may require part cost and part list price to determine total part price 32. In the embodiment shown in FIG. 3, sourcing and procurement process 200 is external to pricing process 60. However, in different embodiments, sourcing and procurement process may be part of pricing process 60.

Management defined data store 76 (shown in FIG. 2) may provide management defined data to sourcing and procurement process 200, parts pricing process 300, labor pricing process 400, hazmat pricing process 500, diagnostic pricing process 100, or combinations thereof. Management defined data may include without limitation, business rules (e.g., if price of a part is greater than $500, then manager 23 must approve the procurement, etc.), maximum and/or minimum charges (e.g., total hazmat price not to exceed 5% of total parts price 32, etc.), mark-ups (e.g., 10% mark-up on all parts, etc.), labor rates (e.g., $60 per hour, etc.), flat fees (e.g., diagnosis of brake symptoms is $50, etc.), filters (e.g., vendor filters, manufacturer filters, part number filters, brand filters, etc.), or combinations thereof.

In other embodiments, pricing process 60 may include without limitation, additional processes, different processes, or combinations thereof. The arrangement of the processes of pricing process 60 may be varied in certain embodiments. For example, communication between the various processes may be varied in certain embodiments. In addition, in some embodiments, pricing process 60 may be in communication with other processes that may be outside pricing process 60.

In select embodiments, the processes shown in FIG. 3, including without limitation pricing process 60, sourcing and procurement process 200, sub-processes within pricing process 60, sub-processes within sourcing and procurement process 200, or combinations thereof, may be performed via software run by on a computer system. This approach may enable partial automation and/or complete automation of certain processes, sub-processes, steps, blocks, etc.

In addition, in some embodiments, information required by a particular process, sub-process, step, block, phase, etc. of sourcing and procurement process 200 and/or pricing process 60 may be stored in a database. Such a database may store any suitable data and/or information required by a certain process, sub-process, step, block, phase, etc.

It is to be understood, that a database may be implemented by any suitable means including without limitation, a commercially available software tool, an in-house developed tool, or combinations thereof. Further, a database may be stored on any suitable means of storage. Examples of suitable means includes without limitation, hard drives, CD-ROM, DVD-ROM, Zip disk, any computer media, or combinations thereof. Still further, the information stored in a database may be updated periodically, on an as needed basis, or in real time. These updates may be performed for any suitable reason including without limitation to add new data, to delete data, to modify data, or combinations thereof.

In select embodiments, updates to databases employed in pricing process 60, sourcing and procurement process 200, sub-process within pricing process 60, sub-process within sourcing and procurement process 200, or combinations thereof may be controlled by manager 23. In particular, by controlling such databases, manager 23 may be able to more precisely control financials of service center 20 including without limitation, total diagnostic price 36, total labor price 34, total parts price 32, total hazmat price 38, total customer price 40, revenues, profits, or combinations thereof. In addition, in certain embodiments, database(s) employed in pricing process 60, sourcing and procurement process 200, sub-process within pricing process 60, sub-process within sourcing and procurement process 200, or combinations thereof may be stored and updated in a single location (e.g., management defined data store 76). In this manner, consistency in pricing may be achieved (i.e., reduction in pricing disparities).

D. Symptom Tree

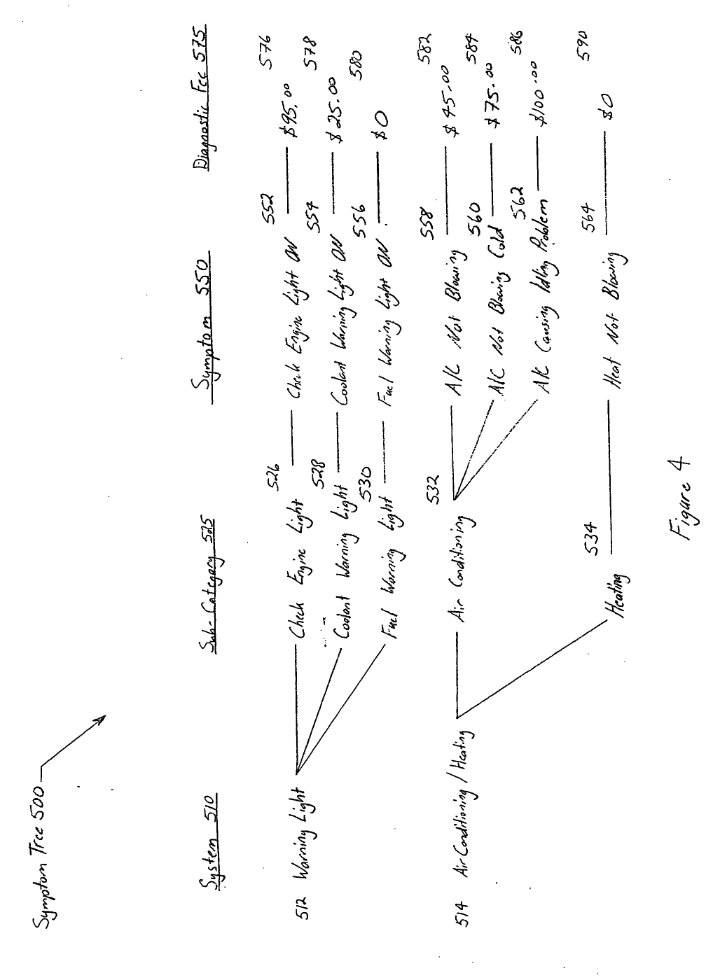

FIG. 4 shows an embodiment of a symptom tree 500 that graphically illustrates a logical breakdown of vehicle 25. Symptom tree 500 comprises systems 510, sub-categories 525, symptoms 550, and diagnostic fees 575. In addition, symptom tree 500 graphically illustrates relationships between systems 510, sub-categories 525, symptoms 550, and diagnostic fees 575.

In general, systems 510 may represent any logical breakdown of vehicle 25, including without limitation, breakdown by components, functions, parts, locations, etc. For example, systems 510 may include a “Warning Lights” system 512, an “Air Conditioning/Heating” system 514, a “Brakes” system (not shown), an “Exhaust” system (not shown), an “Engine” (not shown), etc. In different embodiments (not illustrated), symptom tree 500 may include without limitation, additional and/or different systems 510, sub-categories 525, symptoms 550, diagnostic fees 575, or combinations thereof.

In general, sub-categories 525 may represent any suitable breakdown of each system 510 including without limitation, breakdown by components, functions, subsystems, parts, locations, etc. For example, “Warning Lights” system 512 is broken down into a “Check Engine Light” subcategory 526, a “Coolant Warning Light” sub-category 528, and a “Fuel Warning Light” sub-category 530.

One or more symptom(s) 550, indicating a possible problem with sub-category 525, may be associated with each sub-category 525. For example, an “A/C Not Blowing” symptom 558, an “A/C Not Blowing Cold” symptom 560, and an “A/C Causing Idling Problems” symptom 562 are symptoms associated with problems with an “Air Conditioning” sub-category 532. In the embodiment of symptom tree 500 illustrated in FIG. 4, a diagnostic fee 575 is assigned to each symptom 550. For example, a diagnostic fee 584 of $75 is assigned to “A/C Not Blowing Cold” symptom 560. Some symptoms 550 may have an associated diagnostic fee 575 of zero. By including diagnostic fees 575, symptom tree 500 may be used as a tool in diagnostics pricing process 100 discussed in detail below.

It is to be understood that vehicle 25 may include one or more system 510, one or more sub-category 525 for each system 510, and/or one or more symptom 550 for each sub-category 525. In addition, a particular sub-category 525 may correlate to more than one system 510, and a symptom 550 may correlate to more than one sub-category 525. In some embodiments, each symptom 550 may have one associated diagnostic fee 575. Further, in some embodiments, sub-categories 525 may be further broken down.

E. Diagnostics Pricing Process

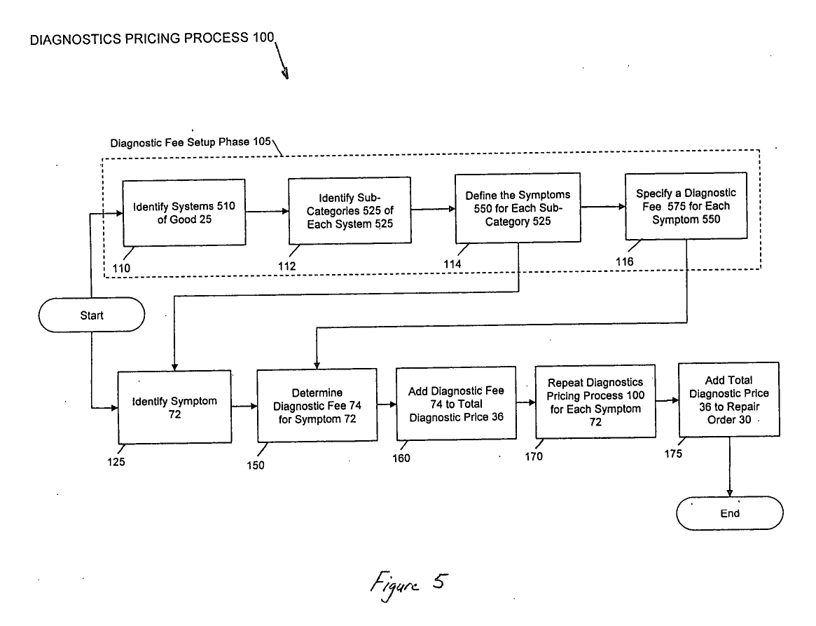

FIG. 5 shows an embodiment of diagnostics pricing process 100. Diagnostics pricing process 100 may be employed to determine total diagnostic price 36.

Referring to FIGS. 4 and 5, a diagnostic fees setup phase 105 begins with block 110 where the systems 510 of vehicle 25 may be identified. For example, vehicle 25 may include “Warning Lights” system 512 and “Air Conditioning/Heating” system 514. Proceeding to block 112, the identified systems 510 may be broken down further into sub-categories 525. For example, “Air Conditioning/Heating” system 514 is divided into “Air Conditioning” sub-category 532 and “Heating” sub-category 534. In block 114, symptoms 550 that indicate potential problems with vehicle 25 may be defined and associated with each sub-category 525. For example, symptoms 550 associated with the “Air Conditioning” sub-category 532 include “A/C Not Blowing” symptom 558, “A/C Not Cold” symptom 560, and “A/C Causing Idling Problems” symptom 552. In block 116, a diagnostic fee 575 may be assigned to each symptom 550. For example, a $45 diagnostic fee 582 may be assigned to “A/C Not Blowing” symptom 558. The diagnostic fee 575 assigned to some symptoms 550 may be zero. A symptom tree 500 similar to that shown in FIG. 4 may be the result of diagnostic fees setup phase 105. The systems 510, sub-categories 525, symptoms 550, and diagnostic fees 575 may be defined by any suitable means, including without limitation by manager 23, a software tool, or combinations thereof. In select embodiments, systems 510, sub-categories 525, symptoms 550, and diagnostic fees 575 may be defined, managed, and updated by manager 23. In particular, by controlling the diagnostic fees 575, manager 23 may be able to more precisely control total diagnostic price 36, total customer price 40, and/or service center 20 revenues.

The results of diagnostic setup phase 105 (e.g., symptom tree 500) may be stored in a data store (e.g., management defined data store 76) that communicates with diagnostic pricing process 100. Each time diagnostic pricing process 100 is performed the information contained within symptom tree 500 may be communicated to diagnostic pricing process 100. For example, symptom tree 500 may be stored in a database that is queried each time diagnostic pricing process 100 is performed. In addition, in certain embodiments, symptom tree 500, including diagnostic fees 575, may be stored and updated in a single location (e.g., management defined data store 76). In this manner, consistency in diagnostic pricing may be achieved.

Referring to FIG. 5, in block 125 a specific symptom 72 exhibited by vehicle 25 may be identified. Without limitation, symptom 72 may be identified by customer 22, manager 23, technician 24, or combinations thereof. For example, when customer 22 brings a vehicle to service center 20, customer 22 may inform manager 23 that vehicle 25 is making a squeaking noise upon braking. Alternatively, or in addition to the input of customer 22, manager 23 or technician 24 may take the car for a test drive to identify symptom 72 exhibited by vehicle 25.

In select embodiments, customer 22 may identify symptom 72 via a symptom tree 500 similar to that shown in FIG. 4. For example, when customer 22 arrives at service center 20, manager 23 may give customer 22 a hardcopy of symptom tree 500 and request customer 22 identify a specific symptom 72 from the list of symptoms 550 shown on symptom tree 500. It is to be understood that symptom tree 500 shown in FIG. 4 is an example, and other forms and variations of symptom tree 500 are possible. For example, symptom tree 500 that may actually be shown to customer 22 may not include diagnostic fees 575. In another embodiment, customer 22 may communicate the symptom 72 to manager 23, and manager 23 may identify specific symptom 72 from the list of symptoms 575 on symptom tree 500. In some embodiments, more than one symptom 72 may be identified in block 125.

Referring again to FIG. 5, the process may then proceed to block 150 where the diagnostic fee 74 for the specific symptom 72 may be determined. In select embodiments, diagnostic fee 74 may be determined via symptom tree 500 as shown in FIG. 4 in light of the specific symptom 72. For example, diagnostic fee 74 may be selected from the list of diagnostic fees 575 identified on symptom tree 500. If more than one symptom 72 was identified in block 125, then a diagnostic fee for each identified symptom 72 may be determined.

The process proceeds to block 160 where diagnostic fee 74 assigned to symptom 72 may be added to total diagnostic price 36. According to block 170, diagnostic pricing process 100 may be repeated for each identified symptom 72. For each repetition of diagnostic pricing process 100, a diagnostic fee 74 for each identified symptom 72 may be added to total diagnostic price 36. For example, referring to FIG. 4, if a first identified symptom 72 is “Check Engine Light ON” symptom 552, and a second identified symptom is “Coolant Warning Light ON” symptom 554, the total diagnostic fee 36 may be $120 ($95 plus $25). Once each diagnostic fee 74 for each symptom 72 has been added to total diagnostic price 36, total diagnostic price 36 may be added to repair order 30 according to block 175.

In select embodiments, more than one symptom 72 may be identified in block 125, and diagnostic pricing process 100 may simultaneously determine the diagnostic fee 74 for each symptom 72 and sum each of these diagnostic fees 74 to determine total diagnostic price 36.

In some embodiments, diagnostic pricing process 100 may be implemented by software run on a computer system. The software may access and query databases for information including without limitation systems 510, sub-categories 525, symptoms 525, diagnostic fees 575, or combinations thereof. The software and associated computer system may enable partial or full automation of diagnostic pricing process 100. For instance, once a specific symptom 72 is identified (or more than one symptoms 72 are identified) the software and associated computer system may automatically calculate total diagnostic fee 36.

F. Parts Sourcing and Procurement Process

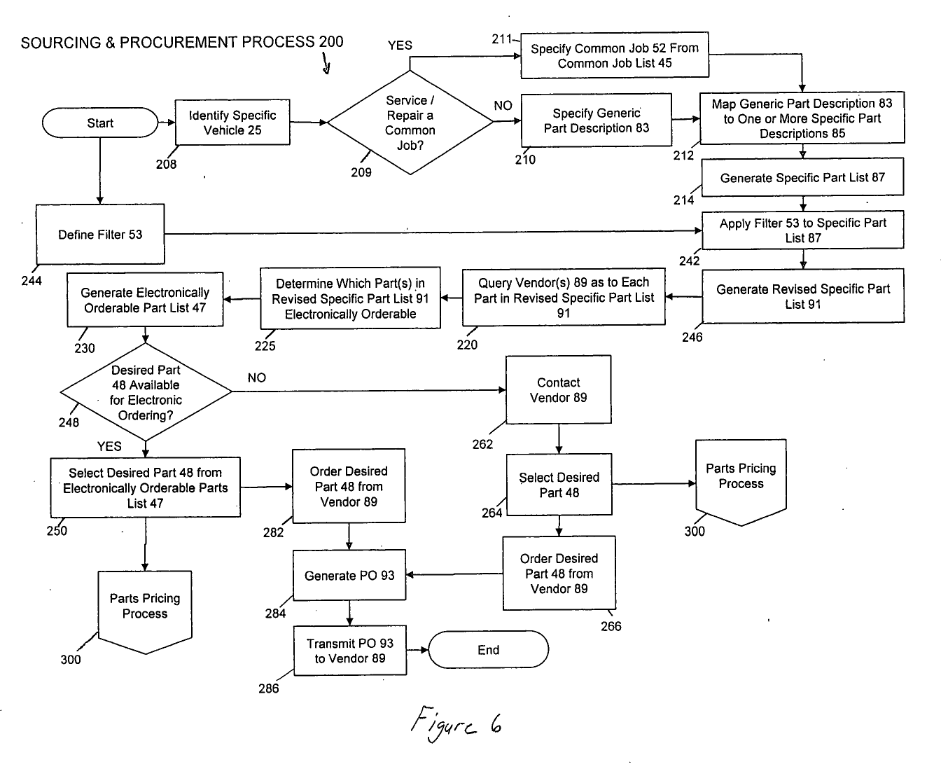

FIG. 6 shows an embodiment of sourcing and procurement process 200. Sourcing and procurement process 200 may generally be used to identify, locate, and order specific parts required to perform services and/or repairs on vehicle 25. In addition, sourcing and procurement process 200 may be used to locate and obtain services required to service and/or repair vehicle 25.

Sourcing and procurement process 200 begins with block 208 where the specific vehicle 25 to be serviced/repaired may be uniquely identified by a user. Vehicle 25 may be uniquely identified by any suitable manner, including without limitation a year/make/model description, vehicle identification number (VIN), engine displacement, or combinations thereof. In general, the user may be any appropriate employee of service center 20 including without limitation, manager 23, technician 24, or combinations thereof. Vehicle 25 may need to be uniquely identified because some automotive parts required to service/repair vehicle 25 may be specifically designed for certain vehicles. For instance, a muffler designed for a 1995 Chevrolet Camaro Z-28 may not be designed for use on a 2000 Mazda Miata. In addition, vehicle 25 may need to be uniquely identified so that a labor guide 84 may be selected in block 426 of labor pricing process 400.

In select embodiments, block 208 may be performed by a software tool run on a computer system. For example, a database may store tables, catalogs, or lists that contain information necessary to uniquely identify vehicle 25. A user may enter a unique description of vehicle 25 (e.g., year/make/model description, VIN, etc.) via a graphical user interface (e.g., management GUI 75) or select vehicle 25 from a list or menu displayed on a user display. The software may then query the database to uniquely identify vehicle 25. For instance, when “VIN 192837” is entered, the software may query the database to correlate the entered “VIN 192837” to a unique vehicle 25 (e.g., a 1991 Ford Mustang with a 5.0 liter engine).

The process proceeds to block 209 where it may be determined whether the particular service/repair to be performed on vehicle 25 is a common job. Generally, a common job may be a relatively common service/repair (e.g., a service/repair that occurs daily). Examples of common jobs may include without limitation an oil change, a water pump change, a tire rotation, etc. In select embodiments, manager 23 may define and update which services/repairs are common jobs. If the service/repair to be performed is a common job, the process proceeds to block 211. If the service/repair to be performed is not a common job, the process proceeds to block 210.

If the service/repair to be performed is a common job, the process proceeds to block 211. In block 211, the user may specify a particular common job 52 from a common job list 45. Common job list 45 may comprise a list of common jobs 52. In certain embodiments, manager 23 may define and updated common job list 45 as necessary. In select embodiments, block 211 may be performed by software run on a computer system. For example, a database may store a preset common job list 45. A user (e.g., technician 24, manager 23, etc.) may enter a particular common job 52 (e.g., “oil change”) via graphical user interface (e.g., technician GUI 65) or select a particular common job 52 from a list of common jobs displayed on a user display The software may then query the database for the particular common job 52. In this manner, part sourcing and procurement, as well as part pricing, labor pricing, and hazmat pricing may be made more efficient.

In some embodiments, each particular common job 52 in common job list 45 may also include a list of generic part descriptions 83 that are associated with the particular common job 52. For example, if common job 52 is “oil change,” this particular common job 52 may include generic part descriptions 83 such as “oil,” “oil filer,” etc. The list of generic part descriptions 83 may be automatically passed to the remainder of sourcing and procurement process 200. In this manner, the one or more generic part descriptions 83 associated with common job 52 (representing the parts required to perform common job 52) may not need to be individually specified in block 210. This approach may improve service center 20 efficiency since specification of a particular common job 52 may automatically result in a list of generic part descriptions 83 associated with common job 52, where a generic part description 83 may be provided for each part required to perform common job 52.

Further, by associating one or more generic part description 83 with each particular common job 52, service center 20 may reduce the risk of inadvertently failing to order certain parts or items (e.g., coolant, oil, etc.) required for a service/repair. Still further, by associating generic part descriptions 83 with each particular common job 52, service center 20 may reduce the risk of failing to charge customer 22 for certain parts or items used for the service/repair that may not have been passed through sourcing and procurement process 200. For example, to change a water-pump, technician 24 may use a container of coolant already located in service center 20 (e.g., on-site inventory). In such a situation, technician 24 may forget to source and procure the coolant via sourcing and procurement process 200 since the coolant has essentially already been procured (e.g., coolant was on-site inventory). However, if a particular common job 52 such as “water-pump change” was specified according to block 211, and this common job 52 automatically included a generic part description 83 for “coolant,” then this oversight may be avoided.

If the service/repair to be performed is not a common job, the process proceeds to block 210. In block 210, the user may specify a generic part description 83. Generic part description 83 may be any phrase or term that typically describes a particular part. For example, the user may specify “brake pads” to search for a specific set of front brake pads. Generic part descriptions 83 may be defined and updated, periodically or in real time, by any suitable means including without limitation, by software (e.g., commercially available software, in-house developed software, etc.), by manual data entry (e.g., by an employee of service center 20 such as manager 23, technician 24, etc.), by electronic vendor catalog(s), or combinations thereof.

In select embodiments, block 210 may be performed by software run on a computer system. For example, a database may store tables, catalogs, or lists of generic part descriptions 83. The user may enter a generic part description 83 (e.g., “brake pads”) via graphical user interface (e.g., management GUI 75) or select a generic part description 83 from a list or menu of generic part descriptions 83 displayed on a user display. The software may then query the database for the particular generic part description 83.

The process proceeds to block 212 where generic part description 83 may be mapped to one or more specific part descriptions 85. Specific part descriptions 85 may correspond to generic part description 83. Further, specific part descriptions 85 may correspond to specific vehicle 25. Thus, specific part descriptions 85 may fall within generic description 83 and be appropriate for use with specific vehicle 25. For example, if vehicle 25 is a 2005 Dodge Caravan, a generic description 83 of “brake pads” may yield several specific part descriptions 85 corresponding to a 2005 Dodge Caravan, such as “2005 Dodge Caravan, front brake pads, semi-metallic, Brand A,” “2005 Dodge Caravan, front brake pads, organic, Brand B,” “2005 Dodge Caravan, rear brake pads, semi-metallic, Brand B,” etc.

It is to be understood that for each generic part description 83 there may one or more specific part descriptions 85. In addition, it is to be understood that there may be several generic part descriptions 83 that yield the same, similar, or overlapping specific part descriptions 85. For example, generic part description “brake pads” and “front brake pads” may both yield specific part descriptions “front brake pads, organic” “front brake pads, semi-metallic,” etc. In alternative embodiments, additional levels of mapping may be performed to further facilitate sourcing.

Specific part descriptions 85 may be defined and updated, periodically or in real time, by any suitable means including without limitation, by software (e.g., commercially available software, in-house developed software, etc.), by manual data entry (e.g., by an employee of service center 20 such as manager 23, technician 24, etc.), by electronic vendor catalog(s), or combinations thereof.

Each specific part description 85 may contain a variety of information including without limitation, part title (e.g., front brake pads, semi-metallic), part brand (e.g., “Brand A”), part number, part SKU, part vendor (e.g., O'Reilly's, AC Delco, NAPA Auto Parts, etc.), part manufacturer, part cost, part list price, or combinations thereof. Further, the specific part descriptions 85 mapped to generic part description 83 may be organized or grouped by any suitable means that a user would find useful. Examples of suitable groupings include without limitation, by part title, brand, vendor, part number, etc. In addition, specific part descriptions 85 may have multiple levels of grouping. For example, specific part descriptions 85 may be grouped first by title, then by brand, then by part number, then by vendor, etc. Table 1 below shows a possible grouping of specific part descriptions 85.

TABLE 1

| Generic Part | | | | |
|---|---|---|---|---|
| Description | Specific Part Descriptions | | | |
| Brake Pads | front brake pads, | Brand A | SKU 1234 | Vendor W |
| | semi-metallic | | | |
| | front brake pads, | Brand A | SKU 1234 | Vendor X |
| | semi-metallic | | | |
| | front brake pads, | Brand B | SKU 2468 | Vendor W |
| | semi-metallic | | | |
| | front brake pads, | Brand A | SKU 1357 | Vendor Y |
| | organic | | | |
| | front brake pads, | Brand C | SKU 3344 | Vendor W |
| | organic | | | |
| | rear brake pads, | Brand E | SKU 7531 | Vendor Y |
| | semi-metallic | | | |
| | rear brake pads, | Brand F | SKU 8877 | Vendor Y |
| | semi-metallic | | | |

Block 212 may be performed by software run on a computer system. A database may store tables, lists, etc. that contain the information necessary to map generic part descriptions 83 to one or more specific part descriptions 85 for a specific vehicle 25. For instance, such a database may contain a table of generic part descriptions 83, a table of specific part descriptions 85, and a table that links each generic part description 83 with corresponding specific part descriptions 85. After the user identifies a specific vehicle 25 and specifies a generic part description 83, the software may query the database for the generic part description 83 and the specific part descriptions 85 associated with generic part description 83, based on specific vehicle 25. In some embodiments, such a database used for mapping may be in communication with electronic vendor catalogs (e.g., through vendor network 79). Without limitation, one or more electronic vendor catalog(s) may provide generic part descriptions 83, specific part descriptions 85 (e.g., part title, part number, part cost, part list price, etc.), or combinations thereof. In addition, any database used for mapping may be periodically, or in real time, updated to account for new generic part descriptions 83, new specific part descriptions 85, etc. For example, if technician 24 enters “brake system” as a generic part description 83, but no specific part descriptions 85 result, then manager 23 may update the database used for mapping to include “brake system” and then link “brake system” generic part description 83 to all relevant specific part descriptions 85. Updating may be performed by any suitable means including without limitation, by software, by manual data entry, by electronic vendor catalog(s), or combinations thereof.

In select embodiments, generic part descriptions 83 may be mapped to one or more specific part descriptions 85 across one or more vendors, one or more brands, one or more manufacturers, etc. By mapping generic part description 83 to one or more specific part descriptions 85, all of the specific parts falling under a particular generic part description 83, across a plurality of vendors, brands, manufacturers, etc., may be accessed at one time by the user. In practice, this capability may improve efficiency in searching for specific parts necessary to service and/or repair vehicle 25. For example, by mapping across multiple vendors, the user may not need to individually contact different vendors to locate specific parts required for a repair. In addition, this capability may enable parts searching by a variety of generic part descriptions. For example, to search specifically for “front brake pads,” technician 24 may enter generic part descriptions 83 “brake pads,” “front brake pads,” etc.

The process proceeds to block 214 where a specific part list 87 may be generated. Specific part list 87 may contain a list of the specific part descriptions 85 mapped to generic part description 83, and appropriate for specific vehicle 25. In some embodiments, specific part list 87 may be provided to the user (e.g., displayed, printed, etc.). For example, when mapping is performed by software running on a computer system, specific part list 87 may be displayed to the user on a computer display. In other embodiments, specific part list 87 may not be provided to the user.

Proceeding to block 242, specific part list 87 may be filtered by applying a filter 53 to specific part list 87, resulting in a revised specific part list 91 (see block 246). Filter 53 may be defined in block 244. Without limitation, filter 53 may exclude certain vendors, certain brands, certain manufacturers, certain part numbers, or combinations thereof, from specific part list 87. For example, filter 53 may permit ordering of front brake pads from “Vendor A”, but not permit the ordering of alternators from “Vendor A.” In another example, filter 53 may not permit any ordering of parts from “Manufacturer X.” Still further, in another example, filter 53 may permit ordering “Brand A” brake pads, but not permit ordering of “Brand B” brake pads. In general, certain vendors, certain brands, certain manufactures, certain part numbers, etc. may be excluded because they may be deemed undesirable, unreliable, etc. In some embodiments, more than one filter 53 may be applied to specific part list 87. Further, in different embodiments, no filter 53 is applied to specific part list 87.

Filter 53 may be defined and updated by any suitable means, including without limitation via software (e.g., commercially available software, in-house developed software, etc.), by manual data entry and/or configuration (e.g., by an employee of service center 20 such as manager 23), or combinations thereof. For example, if service center 20 has had multiple complaints about the wear life of “Brand G” brake pads, manager 23 may update filter 53 to exclude “Brand G” brake pads, thereby preventing the ordering of “Brand G” brake pads.

In some embodiments, specific part list 87 may not be displayed to the user, thus the user may not be aware of any exclusions from specific part list 87 resulting from filtering by filter 53. For example, blocks 214 and 242 may be performed simultaneously such that specific part list 87 may be generated and filtered by filter 53 at the same time, resulting in revised specific part list 91.

Revised specific part list 91 shown in block 246 may result from the filtering of specific part list 87 by application of filter 53. For example, revised specific part list 91 may be specific part list 87 minus the parts excluded by filter 53. If filter 53 does not exclude any specific parts, or if no filter 53 is applied to specific part list 87, revised specific part list 91 in block 246 may be the same as specific part list 87 generated in block 214.

In some embodiments, revised specific part list 91 may be provided to the user (e.g., displayed, printed, etc.). For example, following filtering of specific part list 87 by software running on a computer system, revised specific part list 91 may be displayed to the user on a computer display. In other embodiments, revised specific part list 87 may not be provided to the user.

Without limitation, it is to be understood that anytime a list is generated or created, the generated list may be a completely new list, an existing list plus additional information, an existing list minus some information, an existing list itself, etc.

Sourcing and procurement process 200 proceeds to block 220 where one or more vendor(s) 89 (e.g., parts suppliers, part wholesalers, part manufacturers, etc.) may be queried as to each specific part description 85 in revised specific part list 91. One or more vendor(s) 89 may be queried for any suitable information including without limitation, specific part descriptions 85, part titles, part costs, part list prices, part manufacturers, part vendors, part brands, part availabilities, or combinations thereof. In particular, part availability may refer to whether a vendor 89 has a particular part in-stock or out-of-stock, and if so, when the part is expected to be in-stock. For example, part availability may include without limitation, whether part is currently available (e.g., vendor 89 has part in stock), whether part is not currently available (e.g., vendor 89 does not have part in stock), the estimated date of part availability (e.g., date when vendor 89 expects the have the part in stock), or combinations thereof.

In select embodiments, one or more vendor(s) 89 may be queried electronically by accessing vendor network 79 via a vendor gateway. In some embodiments, vendor network 79 may contain inventory databases, catalogs, etc. of one or more vendor 89. Without limitation, each vendor 89 in vendor network 79 may provide without limitation, part descriptions, part costs, part list prices, part availability, part brands, part manufacturers, part SKUs, or combinations thereof. One or more vendors 89 may be included in the vendor network 79. Thus, the vendor gateway may be electronically linked to vendor network 79 and may provide specific part information (e.g., availability, cost, list price, etc.) to sourcing and procurement process 200. In other embodiments, a vendor gateway may be provided for each vendor 89 in vendor network 79. In certain embodiments, if a particular vendor 89 does not have a specific part available, sourcing may proceed up vendor 89 supply chain. For example, if a retail vendor 89 does not have brake pads in stock, vendor network 79 may check brake pad availability at the warehouse of retail vendor 89.

As previously discussed, if filter 53 does not exclude any specific parts from specific part list 87, or if no filter 53 is applied to specific part list 87, revised specific part list 91 may be the same as specific part list 87. In this scenario, one or more vendor(s) 89 may be queried to determine the availability of each part in specific part list 87.

In some embodiments, blocks 214, 242, 246, and 220 may be performed simultaneously such that revised specific part list 91 may be generated once generic part description 83 is entered. In other embodiments, revised specific part list 91 may be generated at block 246, displayed to a user, and then the user may select an option via a GUI (e.g., technician GUI 65) to query one or more vendor(s) 89 for certain data or information associated with each part in revised specific part list 91 (e.g., part cost, part list price, part description, part manufacturer, part availability, etc.). Part availability data may be included in revised specific part list 91. The data or information associated with each part in revised specific part list 91 may be stored temporarily or permanently by any suitable means. Some examples of suitable means include without limitation, hard drives, random access memory, etc.

In select embodiments (not illustrated), sourcing and procurement process 200 may perform a check of on-hand inventory before proceeding querying vendor(s) 89 in block 220. In general, on-hand inventory may include parts and/or items maintained in inventory or held on-site at service center 20. Examples of on-hand inventory may include without limitation, quarts of oil, gallons of coolant, windshield wiper blades, air intake filters, transmission fluid, etc. If the part or item is on-hand at service center 20, it may not be necessary to query or contact vendor(s) 89 to source and procure the part/item in block 220. In some embodiments, a cost and invoice price may be defined for each good and/or item maintained on-hand at service center 20. In certain embodiments, this defined cost and defined invoice price may be passed to parts pricing process 300. In some embodiments, the defined invoice price may be included in total parts price 32.

The process proceeds to block 225 where revised specific part list 91 may be reviewed to determine which part(s) in revised specific part list 91 are available for electronic ordering. In general, a part is available for electronic ordering if the part can be acquired by electronically ordering the part via vendor network 79. The information regarding whether a particular part may be electronically ordered may be included in revised specific part list 91 to create an electronically orderable parts list 47 in block 230. In other embodiments, electronically orderable parts list 47 may be a new list derived from revised specific part list 91, but only contain a list of parts available for electronic ordering. Electronic ordering capability data for each part may be stored temporarily or permanently by any suitable means. Some examples of suitable means include without limitation, hard drives, random access memory, etc.

Electronically orderable parts list 47 may contain any suitable information including without limitation, part descriptions, part costs, part list prices, part availability (e.g., in-stock), number of parts available part brands, part manufacturers, part vendor, part number, part SKUs, whether part can be electronically ordered, or combinations thereof. The individual parts in electronically orderable parts list 47 may be displayed according to logical groupings.

It is to be understood that a part may be currently in-stock according to block 220, but not electronically orderable from vendor 89 according to block 225. Vice versa, it is to be understood that a part may be out of stock according to block 220, but available for electronic ordering according to block 225 (e.g., part is out of stock, but may be ordered electronically from vendor 89 and the order will be satisfied once the part is in-stock). Further, it is to be understood that electronically orderable parts list 47 may contain no parts if no part on revised list 91 can be order electronically, even though some of the parts on revised list 91 may be available (e.g., currently in-stock).

In some embodiments, blocks 214, 242, 246, 220, and 225 may be performed simultaneously such that electronically orderable parts list 47 may be generated along with part availability data (e.g., part currently in-stock, part not currently in-stock, etc.) once generic part description 83 is entered. In other embodiments, revised specific part list 91 including part availability information may be generated at block 220, displayed to a user, and then the user may select an option via a GUI (e.g., technician GUI 65) to determine which parts are available for electronic ordering to generate electronically orderable parts list 47 in block 225.

The process may proceed to block 248 where it may be determined whether a desired part 48 (e.g., specific part to be used to service/repair vehicle 25) is available for electronic ordering. In some embodiments, block 248 may be performed by reviewing electronically orderable parts list 47 to assess whether electronically orderable parts list 47 contains a desired part 48. For example, electronically orderable parts list 47 may be displayed to the user who may identify a desired part 48 from the list. Electronically orderable parts list 47 may enable the user to review a list of specific parts (e.g., specific part descriptions 85) across one or more vendors, one or more manufacturers, one or more brands, etc. at one time.

Identification of a desired part 48 may be performed by any suitable means. In select embodiments, the user (e.g., technician 24) identifies desirable part 48. In general, the identification of a desired part 48 may be performed in consideration of standard business rules and practice. Standard business rules and practice may depend on a variety of factors including without limitation part cost, part availability (e.g., part currently in-stock, part will be in-stock by certain date, etc.), part quality, part list price, whether part is electronically orderable, or combinations thereof.

If desired part 48 is available for electronic ordering the process proceeds to block 250. If desired part 48 is not available for electronic ordering the process proceeds to block 262. Desired part 48 may not be available for electronic ordering for a variety of reasons including without limitation, electronically orderable parts list 47 contains no desirable parts, electronically orderable parts list 47 contains no parts at all, desired part 48 is not on electronically orderable parts list 47, etc.

If desired part 48 is available for electronic ordering the process proceeds to block 250 where desired part 48 may be selected from electronically orderable parts list 47. In select embodiments, electronically orderable parts list 47 is displayed to the user on a display and the user may then select a desired part 48 from electronically orderable parts list 47. For example, the user may select desired part 48 from electronically orderable parts list 47 via technician GUI 65. In addition, once desired part 48 is selected, a desired part list price 97 and a highest list price 99 may be passed to block 320 of parts pricing process 300.

Still referring to FIG. 6, in block 282, desired part 48 may then be ordered from vendor 89. In select embodiments, desired part 48 may be ordered electronically by software run on a computer system that implements sourcing and procurement process 200. For example, sourcing and procurement process 200 may electronically order desired part 48 via vendor network 79.

In some embodiments, block 282 may be performed only after customer 22 agrees to have service center 20 perform the repairs. This may occur, for example, in situations where customer 22 only wants a price estimate for the repairs. In other embodiments, block 282 may occur automatically, simultaneously with or immediately after selection of desired part 48 in block 250.

If desired part 48 is not available for electronic ordering according to block 248, the process proceeds to block 262 where one or more vendor(s) 89 may be manually contacted to locate a specific part (e.g., desired part 48). Without limitation, one or more vendor(s) 89 may be contacted by phone, e-mail, fax, in person, or combinations thereof. Each vendor 89 contacted may provide a list of specific parts that are sufficient to perform the repair. In addition, each vendor 89 contacted may provide the part list price, part cost, part availability, part brand, part manufacturer, etc. for each specific part located.

In block 264, the user (e.g., technician 24) may select a desired part 48 from vendor 89 according to standard business rules and practice. Standard business rules and practice may depend on a variety of factors including without limitation, part cost, part list price, part availability, part quality or combinations thereof. In addition, once desired part 48 is selected, a desired part cost 59 and a desired part list price 97 may be passed to block 304 of parts pricing process 300.

In block 266, the selected specific part may then be ordered from vendor 89 by any suitable means including phone, fax, e-mail, etc.

In the embodiment illustrated in FIG. 6, once desired part 48 is ordered, via block 266 or block 282, a purchase order (PO) 93 may be generated, according to block 284, and transmitted, according to block 286, to vendor 89 from whom desired part 48 was ordered. In select embodiments, purchase order 93 may be generated and transmitted to vendor 89 electronically via software run on a computer system that implements pricing and procurement process 200. Electronic purchase order generation may advantageously facilitate matching upon invoicing and/or receipt of desired part 48.

In select embodiments, sourcing and procurement process 200 may be implemented by software run on a computer system. The software may access and query databases for information including without limitation, vehicle 25, generic part descriptions 83, specific part descriptions 85, or combinations thereof. Further, the software may access and query one or more vendor(s) 89 electronically via vendor network 79. However, in some embodiments, each individual block may optionally be implemented manually.

G. Parts Pricing

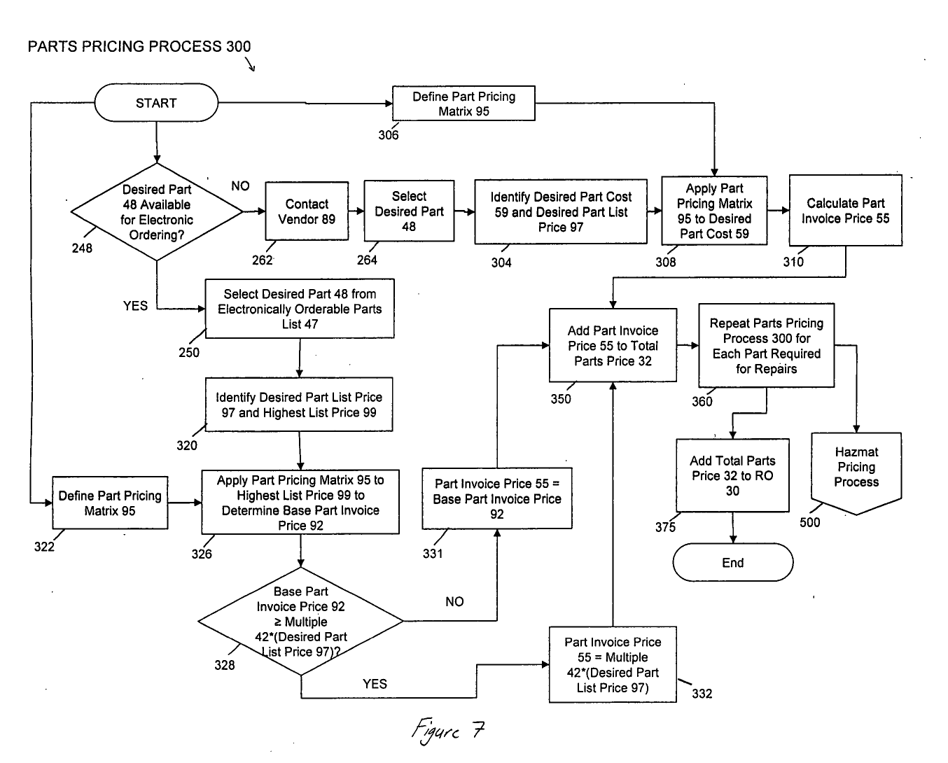

FIG. 7 shows an embodiment of parts pricing process 300. Parts pricing process 300 may generally be used to determine total parts price 32.

Parts pricing process 300 begins in block 248 where it may be determined whether a desired part 48 (e.g., specific part to be used to service/repair vehicle 25) is available for electronic ordering. In select embodiments, this assessment may be the same as block 248 of sourcing and procurement process 200. For instance, block 248 may be performed by reviewing electronically orderable parts list 47 to assess whether electronically orderable parts list 47 contains a desired part 48.

If desired part 48 is available for electronic ordering, then parts pricing process 300 proceeds to block 250. If desired part 48 is not available for electronic ordering, then parts pricing process 300 proceeds to block 262. Desired part 48 may not be available for electronic ordering for a variety of reasons including without limitation, electronically orderable parts list 47 contains no desirable parts, electronically orderable parts list 47 contains no parts, desired part 48 is not on electronically orderable parts list 47, etc.

If desired part 48 is available for electronic ordering the process proceeds to block 250 where desired part 48 may be selected from electronically orderable parts list 47. In select embodiments, the selection of a desired part 48 maybe the same as block 250 of sourcing and procurement process 200. Desired part 48 may be selected according to standard business rules and practice. Standard business rules and practice may depend on a variety of factors including without limitation, part cost, part list price, part availability, whether part is electronically orderable, part quality or combinations thereof. In certain embodiments, electronically orderable parts list 47 is displayed to the user on display and the user may then select a desired part 48 from electronically orderable parts list 47. For example, the user may select desired part 48 from electronically orderable parts list 47 by via technician GUI 65.

In addition, by selecting a particular desired part 48, a desired part list price 97 (e.g., the list price of desired part 48) and a highest list price 99 (e.g., the highest list price in electronically orderable parts list 47) may be identified according to block 320. In select embodiments, desired part list price 97 may be identified from desired part 48 description in electronically orderable parts list 47. In addition, highest list price 99 associated with the part with the highest list price in electronically orderable parts list 47 may be identified from electronically orderable parts list 47. The part with the highest list price (e.g., highest list price 99) may be the same part or a different part from desired part 48. In other embodiments, desired part list price 97, highest list price 99 or combinations thereof, may identified from revised specific part list 91 or specific part list 87 shown in sourcing and procurement process 200.

The process proceeds to block 326 where a part pricing matrix 95 may be applied to highest list price 99 to determine a base part invoice price 92. In alternative embodiments, parts pricing matrix 95 may be applied to desired part list price 97 or the desired part cost. However, by applying part pricing matrix 95 to the selected part cost, service center 20 may be sacrificing mark-ups, and hence revenues, that the market may bear. The part pricing matrix 95 may be defined in block 322.

In general, a matrix may be used to mark-up or discount (i.e., mark-down) a particular number or value including without limitation, part cost, labor hours, book time, fees, or combinations thereof. A matrix may take any suitable form including without limitation a document, table, database, list, etc. Further, a matrix may define mark-ups and/or discounts in any suitable manner including without limitation, percentages (e.g., 10%, 105%, etc.), dollars (e.g., $8), hours (e.g., 1.25 hours), etc. In select embodiments, a matrix may define different mark-ups and/or discounts for different ranges of values including without limitation part list prices, part costs, book times, etc. For example, part pricing matrix 95 may define a 20% mark-up to part cost, for part costs between $0 and $100, a 15% mark-up to part cost for part costs between $100.01 and $300. See Table 2 below. Further, in certain embodiments, a matrix may be a flat mark-up or discount (e.g., 8% mark-up to part cost, regardless of part cost). Still further, in select embodiments, the amount of mark-up decreases as the range value increases. In different embodiments, mark-ups and/or discounts may be achieved by means other than a matrix.

TABLE 2

| Part Cost | Mark-up/Discount |
|---|---|
| $0 to $100 | 20% |
| $100.01 to $300 | 15% |
| $300.01 to $1000 | 10% |
| $1000 and up | 3% |

In general, pricing process 60 may utilize a variety of matrices (e.g., labor matrices, parts matrices, diagnostic matrices, hazmat matrices, etc.). In select embodiments, a matrix or matrices may be stored in a data store (e.g., management defined data store 76, database, etc.) that is accessed as needed by software run on a computer system.

Since each matrix may affect total customer price 40, and because it may be desirable to avoid disparities in pricing, in select embodiments, manager 23 may define, manage, and update each matrix used in pricing process 60. Further, control of a matrix or matrices may enable strategic control over pricing (e.g., parts pricing, labor pricing, hazmat pricing, diagnostic pricing, etc.). Generally, a user (e.g., manager 23) may define a matrix by defining cost, hour, or price ranges and corresponding mark-ups/discounts for each defined range. The mark-ups/discounts defined in a matrix may be determined by a variety of factors including without limitation, current market price, current demand, current supply, or combinations thereof.

Once defined, and updated as necessary, the various processes and sub-processes of pricing process 60 may be restricted to the defined matrices, thereby ensuring consistency in mark-ups and/or discounts across customers, employees, repairs, etc. For example, in marking-up the price of parts, technician 23 may have no discretion as to the amount of mark-up but rather may be limited to the mark-ups defined in parts pricing matrix 95.

Referring again to FIG. 7, a base part invoice price 92 may be determined in block 326 by applying part pricing matrix 95 to highest list price 99. This may result in a mark-up or discount of highest list price 99.

In certain embodiments, parts pricing process 300 proceeds to block 328 where base part invoice price 92 may be compared to a maximum part price. The maximum part price may be the product of desired part list price 97 and a multiple 42. Multiple 42 may be any suitable number including without limitation, an integer, a rational number, a fraction, etc. In select embodiments, multiple 42 may be two. According to block 331, if base part invoice price 92 is less than the maximum part price (e.g., multiple 42 times desired part list price 97), then part invoice price 55 may be base part invoice price 92 as calculated in block 326. However, according to block 332, if part invoice price 92 is greater than or equal to the maximum part price (e.g., multiple 42 times the desired part list price 97), then part invoice price 55 may be capped at the maximum part price (e.g., multiple 42 times desired part list price 97). In this manner, parts pricing process 300 may allow for mark-ups, yet minimizes the incentive to select the cheapest, and often lowest quality, part. For example, if customer 22 was always charged the highest list price 99, or price resulting from a mark-up of highest list price 99 (e.g., base part invoice price 92), technician 24 may have an incentive to always select the part with the lowest cost to maximize the effective mark-up on the part. For instance, if three parts are available with costs of $1, $5, and $10 (highest list price 99), there may be an incentive for technician 24 to choose the $1 part to ensure a maximum effective mark-up of at least $9 (base part invoice price 92 will be at least $10). However, the cheapest part may be a poor choice for customer 22 (e.g., cheapest part may also be the lowest quality part). To overcome this potential problem, the logic in parts pricing process 300 may reduce the incentive to choose the cheapest part because part invoice price 55 passed to customer 22 may be capped by the maximum part price (e.g., multiple 42 times the desired part list price 97).

If desired part 48 is not available for electronic ordering according to block 248, the process proceeds to block 262 where one or more vendor(s) 89 may be manually contacted to locate a specific part (e.g., desired part 48). Without limitation, one or more vendor(s) 89 may be contacted by phone, e-mail, fax, in person, or combinations thereof. Each vendor 89 contacted may provide a list of specific parts that are sufficient to perform the repair. In addition, each vendor 89 contacted may provide the part list price, part cost, part availability, part brand, part manufacturer, etc. for each specific part located. In select embodiments, block 262 in parts pricing process 300 may be the same as block 262 of sourcing and procurement process 200.

In block 264, the user (e.g., technician 24) may select a desired part 48 from vendor 89 according to standard business rules and practice. Standard business rules and practice may depend on a variety of factors including without limitation, part cost, part list price, part availability, part quality or combinations thereof.

In addition, by selecting a particular desired part 48, a desired part cost 59 (e.g., the cost of desired part 48) and a desired part list price 97 (e.g., the list price of desired part 48) may be identified according to block 304. In select embodiments, desired part cost 59 and desired part list price 97 may have been obtained from vendor 89 in block 264 of sourcing and procurement process 200 and passed to parts pricing process 300. In different embodiments, if desired part cost 59 and desired part list price 97 was not already obtained from the vendor in sourcing and procurement process 300, the vendor may be contacted by phone, e-mail, fax, or otherwise to obtain desired part cost 59 and desired part list price 97. Further, in select embodiments, desired part cost 59 and desired part list price 97 may be identified from desired part 48 description in electronically orderable parts list 47, revised specific part list 91, or specific part list 87 shown in sourcing and procurement process 200.

The process proceeds to block 308 where a part pricing matrix 95 may be applied to desired part cost 59 to determine a part invoice price 55. Part pricing matrix 95 may be defined in block 306 and applied to selected part cost 59 in block 308.

In some embodiments, more than one part pricing matrix 95 may be defined in block 306. For example, manager 23 may define a specific part pricing matrix 95 for desired part 48 classification. For example, if desired part 48 comprises a commodity type part, manager 23 may choose to apply a part pricing matrix 95 specifically defined for commodity parts. In some embodiments, the part pricing matrix 95 selected and applied to desired part cost 59 may be the part pricing matrix 95 that yields a part invoice price 55 relatively close to desired part list price 97. This approach may permit some mark-up above desired part list price 97, yet ensure relative consistency between part invoice price 55 and desired part list price 97.

Still referring to FIG. 7, part invoice price 55 may be calculated in block 310 by adjusting desired part cost 59 by the appropriate mark-up or discount specified in part pricing matrix 95. For example, if part pricing matrix 95 defines a 15% mark-up to selected part cost 59 between $100.01 and $300, and selected part cost 59 is $200, then the 15% mark-up should be chosen and the $200 part cost should be marked up accordingly to $210 (e.g., part invoice price 92).

Whether desired part 48 is electronically orderable or not, the process proceeds to block 350 where part invoice price 55 as determined in block 310, 331, and/or 332 may be added to total part price 32. According to block 360, part pricing process 300 may be repeated for each desired part 48 required to repair vehicle 25. In different embodiments, part invoice price 55 of each desired part 48 required to perform a service or repair, and total parts price 32, are calculated on a single pass through parts pricing process 300.

The process proceeds to block 375 where total parts price 32 may be added to repair order 30 as a component of total customer price 40. Total parts price 32 may be sum of the part invoice price 55 for each desired part 48 from block 310, 331, 332 or combinations thereof. In addition, total parts price 32 may be provided to hazmat pricing process 500.

In some embodiments, part pricing process 300 may be implemented by software run on a computer system. The software may access and query databases for information including without limitation desired part list price 97, desired part cost 59, highest list price 99, multiple 42, part pricing matrix 95, or combinations thereof. The software and associated computer system may enable part pricing process 300 to be partially automated or completely automated. For instance, if desired part 48 is electronically orderable, once desired part 48 is selected in block 250, the software and associated computer system may automatically perform the remainder of part pricing process 300. In this embodiment, “black box” part pricing may be possible with part pricing system 300.

H. Labor Pricing

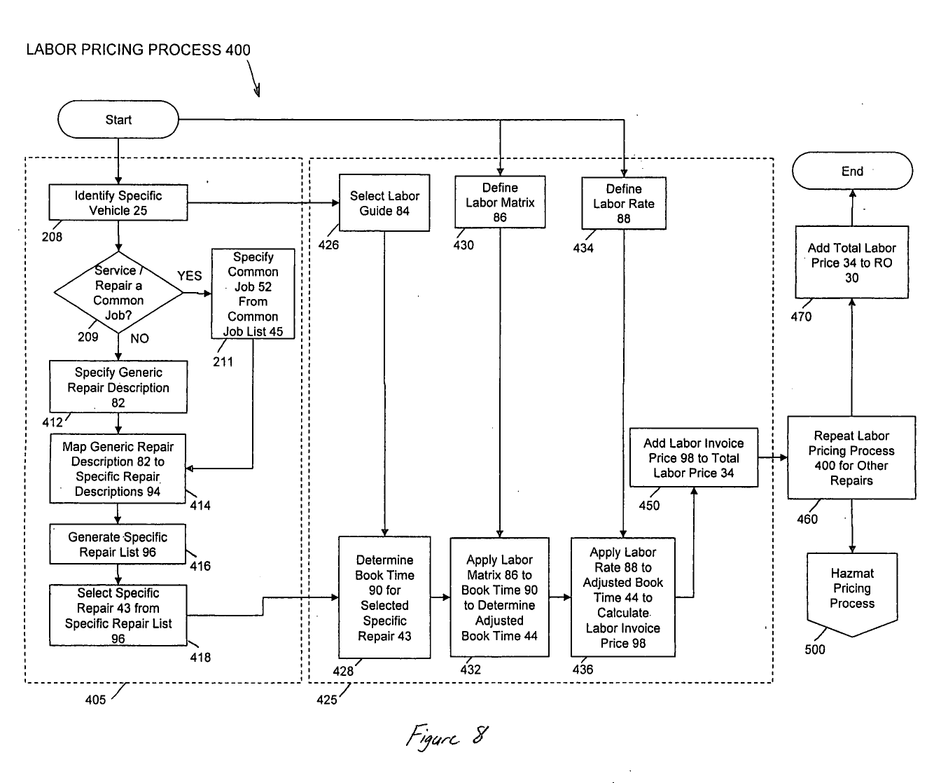

FIG. 8 shows an embodiment of labor pricing process 400. Labor pricing process 400 may generally be employed to determine total labor price 34.

Labor pricing process 400 begins with a repair identification phase 405. In block 208, the specific vehicle 25 to be serviced/repaired may be uniquely identified by a user. Vehicle 25 may be uniquely identified by any suitable manner, including without limitation a year/make/model description, vehicle identification number (VIN), engine displacement, or combinations thereof. In general, the user may be any appropriate employee of service center 20 including without limitation, manager 23, technician 24, or combinations thereof. The specific vehicle 25 to be repaired may need to be uniquely identified so that a labor guide 84 may be selected in block 426. In some embodiments, specific vehicle 25 identified in block 208 of sourcing and procurement process 200 may be communicated to labor pricing process 400, or vice versa. In different embodiments, separate and independent processes may be performed to uniquely identify vehicle 25 in sourcing and procurement process 200 and labor pricing process 400.

In select embodiments, block 208 may be performed via a software tool run on a computer system. For example, a database may store tables, catalogs, or lists that contain information necessary to uniquely identify vehicle 25. A user may enter a unique description of vehicle 25 (e.g., year/make/model description, VIN, etc.) via graphical user interface (e.g., management GUI 75) or select vehicle 25 from a list of vehicles 25 displayed on a user display. The software may then query the database to uniquely identify vehicle 25. For instance, when “VIN 192837” is entered, the software may query the database, which may correlate the entered “VIN 192837” to a unique vehicle 25 (e.g., a 1991 Ford Mustang with a 5.0 liter engine).

The process proceeds to block 209 where it may be determined whether the particular service/repair to be performed on vehicle 25 is a common job. If the service/repair to be performed is a common job, the process proceeds to block 211. If the service/repair to be performed is not a common job, the process proceeds to block 414. Generally, a common job may be a relatively common service/repair (e.g., a service/repair that occurs daily). Examples of common jobs may include without limitation an oil change, a water pump change, a tire rotation, etc. A user (e.g., manager 23) may define what services/repairs are common jobs.

If the service/repair to be performed is a common job, the process proceeds to block 211. In block 211, the user may specify a particular common job 52 from a common job list 45. Common job list 45 may comprise a list of common jobs 52. A user (e.g., manager 23) may define and updated common job list 45 as necessary. In select embodiments, block 211 may be performed by a software tool run on a computer system. For example, a database may store a preset list of common jobs. The user may enter a particular common job 52 (e.g., “oil change”) via graphical user interface (e.g., technician GUI 65) or select common job 52 from a list of common jobs displayed on a user display The software may then query the database for the particular common job 52.

In some embodiments, each particular common job 52 in common job list 45 may also include a list of generic repair descriptions 82 that are associated with the particular common job 52. For example, a common job 52 “tire rotation and balance” may include generic repair descriptions 83 such as “rotate tires,” “balance tires,” “verify air pressure” etc. The list of generic repair descriptions 82 may be automatically passed to the remainder of labor pricing process 400, respectively. In this manner, a generic repair description 82 may not need to be specified according to block 412 since it may already be determined based on the particular common job 52 specified.

Further, by associating generic repair descriptions 82 with each particular common job 52, service center 20 may reduce the risk of inadvertently failing to charge customer 22 for certain repairs actually performed that may not have been passed through labor pricing process 400.

In select embodiments, the determination of whether a service/repair is a common job (block 209) and specification of a particular common job 52 from common job list 45 (block 211) in both sourcing and procurement process 200 and labor pricing process 400 may be the same.

If the service/repair to be performed is not a common job, the process proceeds to block 412. In block 412, the user may specify a generic repair description 82. Generic repair description 82 may be any phrase or term that typically describes a particular repair. For example, the user may specify “brake job” (e.g., generic repair description 82) when the front brakes of a vehicle need to be repaired.

In select embodiments, block 412 may be performed via a software tool run on a computer system. For example, a database may store tables, catalogs, or lists of generic repair descriptions 82. The user may enter a generic repair description 82 (e.g., “brake pad”) through a graphical user interface (e.g., technician GUI 76) or select a generic repair description 82 from a list of generic repair descriptions 82 displayed on a user display The software may then query the database for the particular generic repair description 82.

The process proceeds to block 414 where generic repair description 82 may be mapped to one or more specific repair descriptions 94. Specific repair descriptions 92 may correspond to generic repair description 82 and specific vehicle 25. Thus, specific repair descriptions 94 may fall within generic repair description 82 and be appropriate for use with specific vehicle 25. For example, if vehicle 25 is a 2005 Dodge Caravan, “brake job” (e.g., generic repair description 82) may yield several specific repair descriptions 94 corresponding to a 2005 Dodge Caravan, such as “2005 Dodge Caravan, change front brake pads,” “2005 Dodge Caravan, turn front rotors,” “2005 Dodge Caravan, change brake fluid,” “2005 Dodge Caravan, complete front brake job,” etc. Specific repair descriptions 92 may be derived from a labor guide 84 (discussed below). It is to be understood that for each generic repair description 82, there may be one or more specific repair descriptions 94. In addition, it is to be understood that there may be several generic repair descriptions 82 that yield the same or overlapping specific repair descriptions 94. For example, generic repair description “brake job” and “change brakes” may both yield specific repair descriptions “change front brake pads,” “change rear brake pads,” “change brake fluid,” “turn front rotors,” etc. In alternative embodiments, additional levels of mapping may be performed.

Each specific repair description 94 may contain a variety of information including without limitation a specific repair title (e.g., “change front brake pads”), a unique vehicle 25 for which the specific repair description 94 is intended (e.g., 2005 Dodge Caravan), a reference to a specific location of vehicle 25 (e.g., “change right, front window motor), whether the specific repair is a complete system repair vs. partial system repair (e.g., a full brake job vs. changing front or rear brake pads), or combinations thereof. Further, the specific repair descriptions 94 may be organized or grouped by any suitable means that one of ordinary skill in the art would find useful. Examples of suitable groupings include without limitation, by specific repair title, by specific areas of vehicle 25 (e.g., front, rear, right, left, etc.), by complete vs. partial repairs (e.g., a full brake job vs. just changing the brake pads), etc. In addition, specific repair descriptions 94 may have multiple levels of grouping. For example, specific repair descriptions 94 may be grouped first by repair title, then by specific areas of vehicle 25, etc. Table 3 below shows a possible grouping of specific repair descriptions 94.

TABLE 3

| Generic Repair Description | Specific Repair Descriptions | |
|---|---|---|
| Brake Job | Complete brake job | front and rear brakes |
| | Complete brake job | front brakes only |
| | Complete brake job | rear brakes only |
| | Change brake pads | front and rear brakes |
| | Change brake pads | front brakes only |
| | Change brake pads | rear brakes only |
| | Turn rotors | front and rear rotors |
| | Turn rotors | front rotors only |
| | Turn rotors | rear rotors only |
| | Change brake fluid | |

Block 414 may be performed by software run on a computer system. A database may store tables or lists that contain information necessary to map generic repair descriptions 82 to specific repair descriptions 94 for a specific vehicle 25. For instance, such a database may contain a table of generic repair descriptions 82, a table of specific repair descriptions 94, and a table that links each generic repair description 82 with corresponding specific repair descriptions 94. After the user enters or selects a specific vehicle 25 and a generic repair description 82, the software may be employed to query the database based on the vehicle 25 and the generic repair description 82. In some embodiments, the database may be coupled to external databases or catalogs. In addition, such a database may be periodically, or in real time, updated to account for new generic repair descriptions 82, new specific repair descriptions 94, new links between generic repair descriptions 82 and specific repair descriptions 94, etc. For example, if technician 24 enters “change electric window motor” as a generic repair description 82, but no specific repair descriptions 94 result, then manager 23 may update the database to include “change electric window motor” and then link this generic repair description 82 to all relevant specific repair descriptions 94. Updating may be performed by any suitable means including without limitation, manual data entry, by linking to external catalogs, or combinations thereof.

By mapping generic repair descriptions 82 to one or more specific repair descriptions 94, all of the specific repairs falling under a particular generic repair description 83 may be accessed at one time by the user. In practice, this feature may improve efficiency in searching for specific repairs necessary to price labor. In addition, this approach may enable specific repair searching by a variety of generic repair descriptions 82. For example, to search specifically for “turn front rotors,” technician 24 may enter generic repair descriptions 82 “brake job,” “front brake job,” “turn rotors,” etc.

The process proceeds to block 416 where a specific repair list 96 may be generated. Specific repair list 96 may contain a list of specific repairs corresponding to generic repair description 82 and appropriate for specific vehicle 25. For example, in some embodiments, specific repair list 96 may be a list of the specific repair descriptions 94 resulting from the mapping of generic repair description 82 according to block 414.

For each specific repair in specific repair in specific repair list 96 (e.g., specific repair descriptions 94), the information that may be provided in specific repair list 96 includes without limitation, repair descriptions, repair titles, or combinations thereof. In alternative embodiments, specific repair list 96 may be displayed to the user. For example, when mapping is performed by software running on a computer system, specific repair list 96 may be displayed to the user on a computer display. In other embodiments, specific repair list 96 may take a different form (e.g., a printout, etc.).

In some embodiments, blocks 414 and 416 may be performed simultaneously such that specific repair list 96 may be generated once generic part description 83 is entered.

The process proceeds to block 418 where a specific repair 43 to be performed on vehicle 25 may be selected from specific repair list 96. Specific repair 43 may correspond to one of the specific repair descriptions 94. In select embodiments, the user may select (e.g., mouse click or keystroke) the specific repair 43 from the specific repair list 96 that is displayed on the computer display. In addition, the selected specific repair 43 may be passed to block 428.

A labor calculation phase 425 begins with block 426 where an appropriate labor guide 84 may be selected. In general, a labor guide provides time estimates (e.g., a book time 90) for specific repairs to a specific vehicle. For example, a labor guide for a 2002 Toyota Camry may provide a 4.5 hour book time for a complete brake job on a 2002 Toyota Camry. A different labor guide 84 may be provided for each different vehicle 25. For instance, there may be a labor guide for a 2003 Dodge Dakota and a different labor guide for a 1971 Chevrolet Chevelle SS. Thus, the labor guide 84 selected in block 426 may depend on specific vehicle 25 to be repaired.

Block 426 may be performed by software run on a computer system. A labor guide database 33 may store a variety of labor guides 84 for different vehicles 25, and book times 90 for various repairs to the different vehicles 25. After vehicle 25 is uniquely identified in block 208, the software may be employed to query labor guide database 84 based on vehicle 25. In some embodiments, labor guide database 84 may be coupled to external databases or catalogs. In other embodiments, labor guide 84 may be a hardcopy manual of book times for a specific vehicle 25. Labor guide database may be created or may be a pre-existing database. In addition, labor guide database 84 may be periodically, or in real time, updated to account for labor guides 84, changes to book times 90 in labor guides 84, etc. Updating may be performed by any suitable means including without limitation, manual data entry, by linking to external databases, or combinations thereof.

The process proceeds to block 428 where the selected labor guide 84 may be reviewed to determine a book time 90 required to perform selected specific repair 43. In general, book time 90 may be amount of time estimated to perform specific repair 42 on vehicle 25. Block 428 may be performed by software run on a computer system. For example, once specific repair 43 is selected, the software may query the proper labor guide 84 residing in labor guide database 33 for the particular book time 90 corresponding to specific repair 43.

The process proceeds to block 432 where a labor matrix 86 may be applied to book time 90 for selected specific repair 94. Labor matrix 86 may adjust (e.g., mark-up or discount) book time 90, resulting in an adjusted book time 44. By using labor matrix 86 to adjust book time 90, labor pricing process 400 may be able to account for unpredicted or incidental labor costs incurred while performing repairs that may not be accounted for in book time 90. For instance, while changing an exhaust manifold, technician 24 may encounter a seized bolt that needs to be drilled out to proceed with the repair. This unpredicted problem may increase the time spent by technician 24 to change the exhaust manifold, and may not be included in book time 90 provided in labor guide 84.

Labor matrix 86 may be defined in block 430. In some embodiments, labor pricing process 400 may employ more than one labor matrix 86. For example, there may be a labor matrix 86 for labor performed by manager 23, a labor matrix 86 for labor performed by technician 24, etc. In some embodiments, labor matrix 86 may define different mark-ups and/or discounts for different ranges of book time 90. For example, labor matrix 86 may define a 15% book time mark-up for book times (e.g., book time 90) between 0 and 5 hours, a 20% book time mark-up for book times (e.g., book time 90) between 5 and 10 hours, etc. In select embodiments, the amount of mark-ups in labor matrix 86 decrease as book time 90 increases. For example, labor matrix 86 may define a 1.25 hour mark-up for book times (e.g., book time 90) between 0 and 5 hours and a 1.15 hour mark-up for book times (e.g., book time 90) between 5 and 10 hours. Further, in certain embodiments, labor matrix 86 may be a flat mark-up or discount. For example, labor matrix 86 may define a 0.5 hour mark-up for any book time 90. Still further, in different embodiments, no labor matrix 86 is provided, and hence there are no mark-ups nor discounts to book time 90.

Labor matrix 86 may be stored in a database and queried as needed by software run on a computer system. For example, the software may query the database containing labor matrix 86 and automatically apply labor matrix 86 to book time 90 to determine adjusted book time 44.

The process proceeds to block 436 where a labor invoice price 98 may be calculated. Labor invoice price 98 for selected specific repair 43 may be adjusted book time 44 multiplied by a labor rate 88. For example, if adjusted book time 44 is 3 hours and labor rate 88 is $50/hr, then labor invoice price 98 may be $150 (3 hours×$50/hr).

Labor rate 88 may be defined in block 434. In general, labor rate 88 may define an invoice price per unit time (e.g., $60 per hour). In some embodiments, labor pricing process 400 may employ more than one labor rate 88. For example, there may be a labor rate 88 for labor performed by manager 23, a labor rate 88 for labor performed by technician 24, etc.

Labor rate 88 may be stored in a database and queried as needed by software run on a computer system. For example, the software may query the database containing labor rate 88 and automatically apply labor rate 88 to adjusted book time 44 to calculate labor invoice price 98.

The process proceeds to block 450 where labor invoice price 98 for specific repair 43 may be added to total labor price 36. According to block 460, labor pricing process 400 may be repeated for each every other repair performed on vehicle 25. For each repetition of labor pricing process 100, a labor invoice price 98 for each specific repair 43 may be added to total labor price 36 (block 450). For example, if a first specific repair 43 results in a labor invoice price 98 of $150, and a second specific repair 43 results in a labor invoice price 98 of $400, then total labor price 34 may be $550 ($150 plus $400). In different embodiments, the repair invoice price 98 for each specific repair 43 is calculated and summed on a single pass through parts pricing process 300.

The process proceeds to block 470 where total labor price 34 may be added to repair order 30 as a component of total customer price 40. In addition, total labor price 34 may be provided to hazmat pricing process 500.

In some embodiments, labor pricing process 400 may be implemented by software run on a computer system. The software may access and query databases for information including without limitation labor guides 84, book times 90, specific vehicles 25, generic repair descriptions 82, specific repair descriptions 94, labor matrix 86, labor rate 88, or combinations thereof. The software and associated computer system may enable labor pricing process 400 to be completely automated. For instance, once specific repair 43 is selected, the software and associated computer system may automatically perform labor pricing process 400. In this embodiment, “black box” labor pricing may be possible with labor pricing system 400.

I. Hazmat Pricing

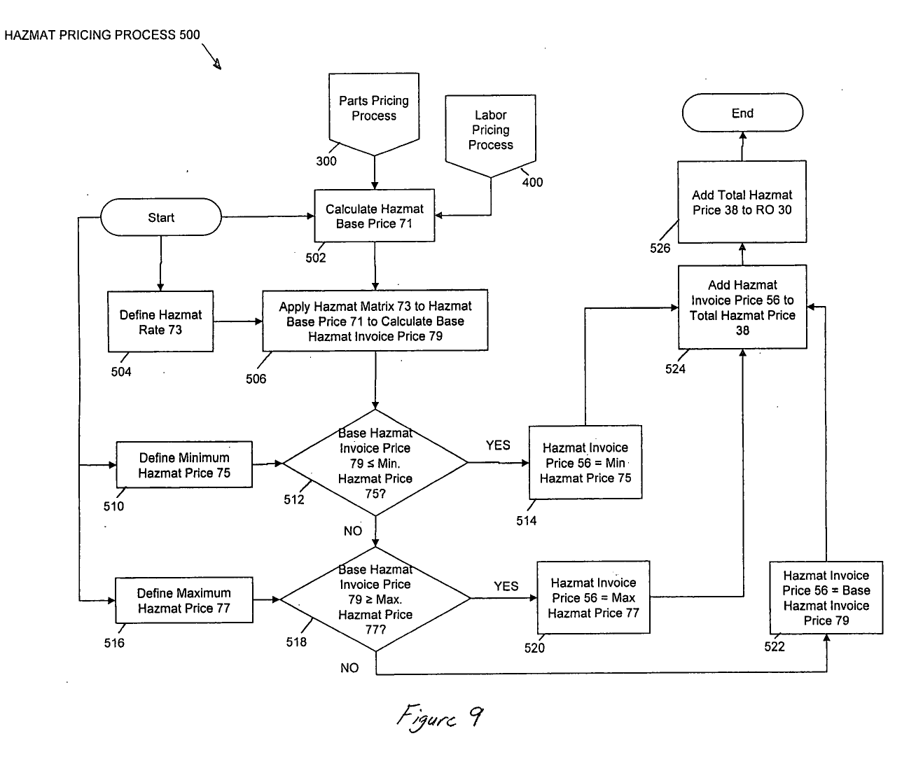

FIG. 9 shows an embodiment of hazmat pricing process 500. Hazmat pricing process 500 may generally be used to determine total hazmat price 38.

Hazmat pricing process 500 beings at block 502 where a hazmat base price 71 may be calculated. In general, hazmat base price 71 may be used as a starting point for calculating total hazmat price 38. Hazmat base price 71 may include without limitation, total parts price 32, total labor price 34, total diagnostics price 36, a flat fee, or combinations thereof. In the embodiment shown in FIG. 9, hazmat base price 71 includes total parts price 32 from parts pricing process 300, and total labor price 34 from labor pricing process 400. In select embodiments, hazmat base price 71 may be the sum of total parts price 32 and total labor price 34.

The process proceeds to block 506 where a base hazmat invoice price 79 may be calculated. Base hazmat invoice price 79 may be hazmat base price 71 multiplied by a hazmat rate 73. For example, if hazmat base price 71 is $1200, and hazmat rate 73 is 0.5%, then base hazmat invoice price 79 may be $60. Base hazmat invoice price 79 may serve to distribute hazmat costs, or other shop costs that may not be directly attributable to a specific customer, across all the customers of service center 20. For example, if service center 20 incurs $100 worth of hazmat costs, this $100 may be distributed by attributing a portion of the $100 cost to customer A, a portion to customer B, a portion to customer C, and so on.

Hazmat rate 73 may be defined in block 504. Hazmat rate 73 may define a percentage of hazmat base price 71 that may be attributed to hazmat costs. In some embodiments, hazmat pricing process 500 may employ more than one hazmat rate 73.

Hazmat rate 73 may be stored in a database and applied as needed by software run on a computer system. For example, the software may query the database containing hazmat rate 73 and automatically apply hazmat rate 73 to hazmat base price 71 to calculate base hazmat invoice price 79.

In blocks 510 and 516, a minimum hazmat price 75 and a maximum hazmat price 77, respectively, may be defined. Minimum hazmat price 510 may define the minimum total hazmat price 38 that may be passed to customer 22 for services/repairs. Maximum hazmat price 77 may define the maximum total hazmat price 38 that may be passed to customer 22 for services/repairs. The minimum and maximum hazmat price may be expressed in currency (e.g., US dollars). Minimum hazmat price 75 and maximum hazmat price 77 may be stored in a database and applied as needed by software run on a computer system. For example, the software may query the database containing minimum hazmat price 75 and maximum hazmat price 77 and automatically apply minimum hazmat price 75 and maximum hazmat price 77 in blocks 512 and 518, respectively. In other embodiments, no minimum hazmat price 75 and/or no maximum hazmat price 77 are provided.

Proceeding to block 512, minimum hazmat price 75 may be compared to base hazmat invoice price 79 to determine a hazmat invoice price 56. In the embodiment shown in FIG. 9, if base hazmat invoice price 79 is less than or equal to minimum hazmat price 75, then hazmat invoice price 56 may be minimum hazmat price 75, as shown in block 514. For example, if minimum hazmat price is $10 and base hazmat invoice price is $7, then hazmat invoice price 56 is $10. However, if base hazmat invoice price 79 is not less than or equal to minimum hazmat price 75, then the process may proceed to block 518. In block 518, maximum hazmat price 77 may be compared to base hazmat invoice price 79 to determine hazmat invoice price 56. In the embodiment shown in FIG. 9, if base hazmat invoice price 79 is greater than or equal to maximum hazmat price 77, then hazmat invoice price 56 may be maximum hazmat price 77, as shown in block 520. For example, if maximum hazmat price 77 is $100 and base hazmat invoice price 79 is $120, then hazmat invoice price 56 is $100 (i.e., hazmat invoice price 56 is limited to maximum hazmat price 77). However, if base hazmat invoice price 79 is less than maximum hazmat price 77 and greater than minimum hazmat price 75, then hazmat invoice price 56 may be base hazmat invoice price 79, as shown in block 522. For example, if maximum hazmat price 77 is $100, minimum hazmat price 75 is $5, and base hazmat invoice price 79 is $95, then hazmat invoice price 56 is $95.

In block 524, hazmat invoice price 56, from block 514, 520, or 522 may be added to total hazmat price 38. In addition, in block 526, total hazmat price 38 may then be added to repair order 30, as a component of total customer price 40.

In some embodiments, hazmat pricing process 500 may be implemented by software run on a computer system. The software may access and query databases for information including without limitation total parts price 32, total labor price 34, hazmat rate 73, minimum hazmat price 75, maximum hazmat price 77, or combinations thereof. The software and associated computer system may enable hazmat pricing process 500 to be partially or completely automated. For instance, once total parts price 32 and total labor price 34 are provided to labor pricing process 500, the software and associated computer system may automatically perform the required calculations and comparisons to determine hazmat invoice price 56. In such an embodiment, “black box” hazmat pricing may be possible with hazmat pricing process 500.

In other embodiments (not illustrated), pricing process 60, procurement process 70, diagnostics pricing process 100, sourcing and procurement process 200, parts pricing process 300, labor pricing process 400, and hazmat pricing process 500 may include without limitation additional steps or blocks, different steps or blocks, fewer steps or blocks, additional phases, or combinations thereof. In addition, the arrangement of the steps or blocks of pricing process 60, procurement process 70, diagnostics pricing process 100, sourcing and procurement process 200, parts pricing process 300, labor pricing process 400, and hazmat pricing process 500 may be varied in certain embodiments (not illustrated). Further, the order of the blocks and phases may be varied in certain embodiments (not illustrated). Still further, the individual blocks and/or phases of pricing process 60, procurement process 70, diagnostics pricing process 100, sourcing and procurement process 200, parts pricing process 300, labor pricing process 400, and hazmat pricing process 500 may be manual, partially automated, or fully automated. Select embodiments of pricing process 60, procurement process 70, diagnostics pricing process 100, sourcing and procurement process 200, parts pricing process 300, labor pricing process 400, and hazmat pricing process 500 may be implemented via software running on a general purpose computer system. General purpose computer systems are discussed in detail hereinafter.

J. Methods Embodied as a Computer System

The disclosed systems and methods may be embodied as a computer system and/or software. In some embodiments, the software takes the form of a web browser accessing development pages. The pages may include Flash multimedia applets and Viewpoint applets that interact via Javascript and XML files. In other embodiments, the software takes the form of a dedicated graphical user interface for developing the disclosed methods and systems from databases of existing information.

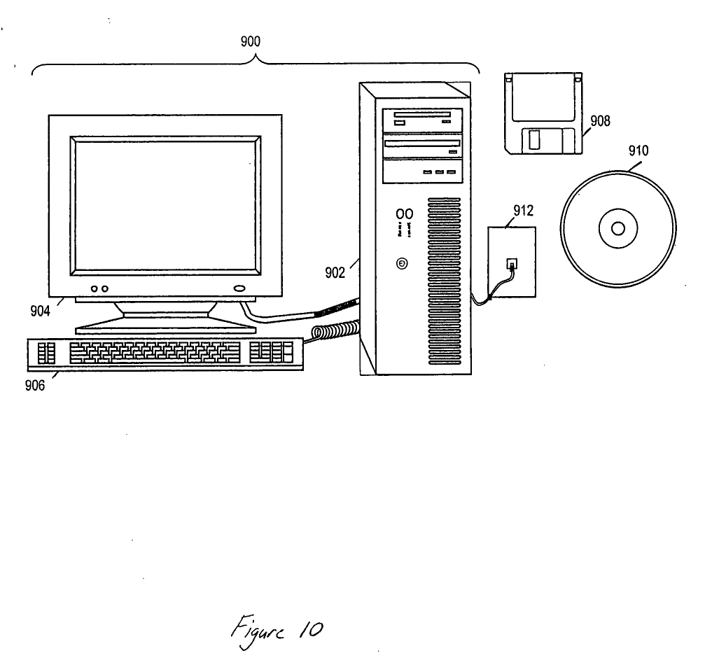

FIG. 10 shows an illustrative system 900 for implementing the disclosed systems and methods (e.g., service center system 50, pricing process 60, procurement process 70, etc.). System 900 is shown as a desktop computer 900, although any electronic device having some amount of computing power coupled to a user interface may be configured to carry out the methods disclosed herein. Among other things, servers, portable computers, personal digital assistants (PDAs) and mobile phones may be configured to carry out aspects of the disclosed methods.

As shown, illustrative system 900 comprises a chassis 902, a display 904, and an input device 906. In some embodiments, system 900 may comprise additional components (e.g., a printer, a scanner, etc.) and/or the components (e.g., chassis 902, display 904, etc.). The chassis 902 comprises a processor, memory, and information storage devices. One or more of the information storage devices may store programs and data on removable storage media such as a floppy disk 908 or an optical disc 910. The chassis 902 may further comprise a network interface that allows the system 900 to receive information via a wired or wireless network, represented in FIG. 10 by a phone jack 912. The information storage media and information transport media (i.e., the networks) are collectively called “information carrier media.”

The chassis 902 is coupled to the display 904 and the input device 906 to interact with a user. The display 904 and the input device 906 may together operate as a user interface. The display 904 is shown as a video monitor, but may take many alternative forms such as a speaker, or other means for communicating information to a user. In certain embodiments of system 900 that contain a printer, the printer may serve as a means for communicating information to a use. The input device 906 is shown as a keyboard, but may similarly take many alternative forms such as a button, a mouse, a keypad, a dial, a motion sensor, a camera, a microphone or other means for receiving information from a user. Both the display 904 and the input device 906 may be integrated into the chassis 902.

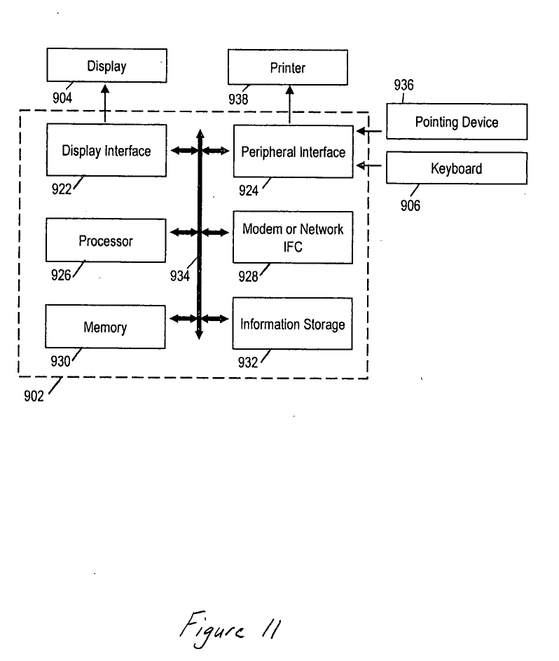

FIG. 11 shows a simplified functional block diagram of system 900. The chassis 902 may comprise a display interface 922, a peripheral interface 924, a processor 926, a modem or other suitable network interface 928, a memory 930, an information storage device 932, and a bus 934. System 900 may be a bus-based computer, with the bus 934 interconnecting the other elements and carrying communications between them. The display interface 922 may take the form of a video card or other suitable display interface that accepts information from the bus 934 and transforms it into a form suitable for the display 904. The peripheral interface 924 may accept signals from the keyboard 906 and other input devices such as a pointing device 216, and transform them into a form suitable for communication on the bus 934. Further, the peripheral interface 924 may accept information from the bus 934 and transform it into a form suitable for a printer 938.

The processor 926 gathers information from other system elements, including input data from the peripheral interface 924, and program instructions and other data from the memory 930, the information storage device 932, or from a remote location via the network interface 928. The processor 926 carries out the program instructions and processes the data accordingly. The program instructions may further configure the processor 926 to send data to other system elements, comprising information for the user which may be communicated via the display interface 922 and the display 904, the peripheral interface 924 and the printer 938, or combinations thereof.

The network interface 928 enables the processor 926 to communicate with remote systems via a network. The memory 930 may serve as a low-latency temporary store of information for the processor 926, and the information storage device 932 may serve as a long term (but higher latency) store of information.

The processor 926, and hence the computer 900 as a whole, operates in accordance with one or more programs stored on the information storage device 932. The processor 926 may copy portions of the programs into the memory 930 for faster access, and may switch between programs or carry out additional programs in response to user actuation of the input device. The additional programs may be retrieved from information the storage device 932 or may be retrieved from remote locations via the network interface 928. One or more of these programs configures system 900 to carry out at least one of the information exploration methods disclosed herein.

While several embodiments have been provided and described in the present disclosure, it should be understood that the disclosed systems and methods may be embodied in many other specific forms without departing from the spirit or scope of the present disclosure. For example, although reference is made to automotive repairs (e.g., sourcing parts for automotive repairs, procuring parts for automotive repairs, and pricing automotive repairs), embodiments of the present invention are not limited to the automotive repair industry, and some embodiments may be used in a variety of repair and service businesses. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein. Accordingly, the scope of protection is not limited to the embodiments described herein, but is only limited by the claims that follow, the scope of which shall include all equivalents of the subject matter of the claims.

What is claimed is:

1. A method for sourcing a part, comprising:
specifying a generic part description for a part;
mapping the generic part description to one or more specific part descriptions across a plurality of vendors; and
generating a list of the one or more specific part descriptions.

2. The method of claim 1, further comprising selecting a desired part from the list of the one or more specific part descriptions.

3. The method of claim 1, further comprising filtering the list of the one or more specific part descriptions to generate a revised specific part list, wherein the step of filtering determines whether to exclude one or more specific part descriptions based on one or more specified criteria.

4. The method of claim 3, wherein the specified criteria comprises vendor name, part brand, part number, part manufacturer, or combinations thereof.

5. The method of claim 3, further comprising determining an availability for each specific part description on the revised specific part list.

6. The method of claim 5, wherein the availability of each specific part description on the revised specific part list is determined by querying the vendor of each specific part description on the revised specific part list.

7. The method of claim 3, further comprising selecting a desired part from the revised specific part list.

8. The method of claim 7, further comprising electronically ordering the desired part.

9. A method, comprising:
generating a list of one or more specific part descriptions;
filtering the one or more specific part descriptions to generate a revised specific part list, wherein the step of filtering determines whether to exclude one or more specific part descriptions based on one or more specified criteria; and
selecting a desired part from the one or more specific part descriptions on the revised specific part list.

10. The method of claim 9, wherein the specified criteria comprises vendor name, part brand, part number, part manufacturer, or combinations thereof.

11. The method of claim 9, wherein the revised specific part list is different from the list of one or more specific part descriptions.

12. The method of claim 9, wherein the list of one or more specific part descriptions is generated by:
specifying a generic part description for a part; and
mapping the generic part description to one or more specific part descriptions across one or more vendors.

13. The method of claim 9, further comprising determining a list price for each specific part description on the revised specific part list.

14. The method of claim 13, further comprising determining a highest list price for the one or more specific part descriptions on the revised specific part list.

15. The method of claim 14, further comprising identifying the desired part list price.

16. The method of claim 15, further comprising applying a part pricing matrix to the highest list price to determine a base part invoice price.

17. The method of claim 16, further comprising determining a part invoice price for the desired part by comparing the base part invoice price to a maximum part price, wherein the maximum part price is a multiple of the desired part list price;
wherein if the base part invoice price is greater than the maximum part price, then the part invoice price equals the maximum part price; and
wherein if the base part invoice price is less than or equal to the maximum part price, then the part invoice price equals the base part invoice price.

18. The method of claim 17, wherein the multiple is two.

19. The method of claim 9, further comprising a labor pricing process to determine a labor invoice price.

20. The method of claim 19, wherein the labor pricing process comprises:
specifying a generic repair description for the repair;
mapping the generic repair description to one or more specific repair descriptions;
selecting a desired repair from the one or more specific repair descriptions;
calculating a labor invoice price for the desired repair.

21. The method of claim 20, wherein the labor invoice price is calculated by:
determining a book time for the desired repair;
applying a labor matrix to the book time to calculate an adjusted book time; and
applying a labor rate to the adjusted book time to calculate the labor invoice price.

22. The method of claim 19, further comprising a diagnostic pricing process to determine a diagnostic fee.

23. The method of claim 22, wherein the diagnostic pricing process comprises:
identifying a symptom exhibited by the vehicle; and
using a symptom tree to determine the diagnostic fee.

24. The method of claim 22, further comprising a hazmat pricing process to determine a hazmat invoice price.

25. The method of claim 24, wherein the hazmat pricing process comprises:
calculating a hazmat base price for the repair;
applying a hazmat matrix to the hazmat base price to determine a base hazmat invoice price;
comparing the base hazmat invoice price to a minimum hazmat price and comparing the base hazmat invoice price to a maximum hazmat price to determine the hazmat invoice price;
wherein if the base hazmat invoice price is less than the minimum hazmat price, then the hazmat invoice price is the minimum hazmat price;
wherein if the base hazmat invoice price is greater than the maximum hazmat price, then the hazmat invoice price is the maximum hazmat price;
wherein if the base hazmat invoice price is greater than or equal to the minimum hazmat price and less than or equal to the maximum hazmat price, then the hazmat invoice price is the base hazmat invoice price.

26. A method for pricing a part, comprising:
generating a list of one or more specific part descriptions;
determining a list price for each specific part description;
determining a highest list price for the one or more specific part descriptions;
selecting a desired part from the one or more specific part descriptions;
identifying the desired part list price;
applying a part pricing matrix to the highest list price to determine a base part invoice price;
determining a part invoice price for the desired part by comparing the base part invoice price to a maximum part price, wherein the maximum part price is a multiple of the desired part list price;
wherein if the base part invoice price is greater than the maximum part price, then the part invoice price equals the maximum part price; and
wherein if the base part invoice price is less than or equal to the maximum part price, then the part invoice price equals the base part invoice price.

27. The method of claim 26, wherein the list of one or more specific part descriptions is generated by:
specifying a generic part description for a part; and
mapping the generic part description to one or more specific part descriptions across a plurality of vendors.

28. The method of claim 26, further comprising filtering the one or more specific part descriptions to generate a revised specific part list, wherein the step of filtering determines whether to exclude one or more specific part descriptions based on one or more specified criteria.

29. The method of claim 28, wherein the specified criteria comprises vendor name, part brand, part number, part manufacturer, or combinations thereof.

30. The method of claim 28, wherein the revised specific part list is different from the list of one or more specific part descriptions.

31. The method of claim 28, wherein the desired part is selected from the one or more specific part descriptions on the revised specific part list.

32. The method of claim 26, wherein the multiple is two.

33. A method for sourcing and pricing a part, comprising:
specifying a generic part description for a part;
mapping the generic part description to one or more specific part descriptions, wherein each of the one or more specific part descriptions has a list price;
selecting a desired part from the one or more specific part descriptions;
identifying the list price for the desired part from the one or more specific part descriptions;
identifying the highest list price from the one or more specific part descriptions;
applying a part pricing matrix to the highest list price to calculate a base part invoice price;
determining a part invoice price by comparing whether the base part invoice price is greater than a maximum part price, wherein the maximum part price is a multiple of the desired part list price;
wherein if the base part invoice price is greater than the maximum part price, then the part invoice price equals the maximum part price, and wherein if the base part invoice price is less than or equal to the maximum part price, then the part invoice price equals the base part invoice price.

34. The method of claim 33, wherein the multiple is two.

35. The method of claim 33, comprising filtering the one or more specific part descriptions to generate a revised specific part list, wherein the step of filtering determines whether to exclude one or more specific part descriptions based on one or more specified criteria.

36. The method of claim 35, wherein the step of filtering reduces the number of specific part descriptions.

37. The method of claim 35, wherein the specified criteria comprises vendor name, part brand, part number, part manufacturer, or combinations thereof.

38. The method of claim 35, wherein the desired part is selected from the revised specific part list.

39. The method of claim 33, further comprising electronically ordering the desired part.

40. The method of claim 33, wherein mapping further comprises mapping the generic part description to one or more specific part descriptions across a plurality of vendors.

41. A method for sourcing a part, comprising:
specifying a generic part description for a part;
mapping the generic part description to one or more specific part descriptions across one or more vendors; and
generating a list of the one or more specific part descriptions.

42. The method of claim 41, further comprising filtering the list of the one or more specific part descriptions to generate a revised specific part list, wherein the step of filtering determines whether to exclude one or more specific part descriptions based on one or more specified criteria.

43. The method of claim 42, wherein the specified criteria comprises vendor name, part brand, part number, part manufacturer, or combinations thereof.

44. The method of claim 42, further comprising selecting a desired part from the revised specific part list.

45. A parts sourcing apparatus, comprising:
a display;
a user input device;
a memory that stores software; and
a processor coupled to the memory to execute the software, wherein the software configures the processor to interact with a user via the display and user input device, and wherein the software further configures the processor to:
allow the user to specify a generic part description;
map the generic part description to one or more specific part descriptions across a plurality of vendors;
generate a list of the one or more specific part descriptions;
display the list of the one or more specific part descriptions on the display; and
allow the user to specify a desired part from the list of the one or more specific part descriptions.

46. The apparatus of claim 45, wherein the software further configures the processor to apply a filter to the list of the one or more specific part descriptions to generate a revised specific part list, wherein the filter determines whether to exclude one or more specific part descriptions based on one or more specified criteria.

47. The apparatus of claim 46, wherein the specified criteria comprises vendor name, part brand, part number, part manufacturer, or combinations thereof.

48. The apparatus of claim 46, wherein the software further configures the processor determine an availability for each specific part description on the revised specific part list.

49. The apparatus of claim 48, wherein the software configures the processor to determine the availability of each specific part description by querying the vendor of each specific part description on the revised specific part list.

50. The apparatus of claim 46, wherein the software configures the processor to allow the user to specify the desired part from the revised specific part list.

51. The apparatus of claim 46, wherein the revised specific part list has fewer specific part descriptions than the generated list of the one or more specific part descriptions.

52. The apparatus of claim 45, wherein the software further configures the processor to electronically order the desired part.

53. An apparatus to price a part, comprising:
a display;
a user input device;
a memory that stores software; and
a processor coupled to the memory to execute the software, wherein the software configures the processor to interact with a user via the display and user input device, and wherein the software further configures the processor to:
generate a list of the one or more specific part descriptions;
apply a filter to the list of the one or more specific part descriptions to generate a revised specific part list, wherein the filter determines whether to exclude one or more specific part descriptions based on one or more specified criteria;
display the revised specific part list on the display;
allow the user to specify a desired part from the revised specific part list; and
determine a part invoice price for the desired part.

54. The apparatus of claim 53, wherein the specified criteria comprises vendor name, part brand, part number, part manufacturer, or combinations thereof.

55. The apparatus of claim 53, wherein the software configures the processor to generate the list of one or more specific part descriptions by configuring the processor to:
allow the user to specify a generic part description for a part; and
map the generic part description to one or more specific part descriptions across a plurality of vendors.

56. The apparatus of claim 53, wherein the software further configures the processor to determine a list price for each specific part description on the revised specific part list.

57. The apparatus of claim 56, wherein the software further configures the processor to determine a highest list price for the one or more specific part descriptions on the revised specific part list.

58. The apparatus of claim 57, wherein the software further configures the processor to identify the list price of the desired part.

59. The apparatus of claim 58, wherein the software further configures the processor to apply a part pricing matrix to the highest list price to determine a base part invoice price.

60. The apparatus of claim 59, wherein the software configures the processor to determine the part invoice price for the desired part by configuring the processor to:
calculate a product, wherein the product is a multiplier multiplied by the desired part list price;
compare the base part invoice price to the product;
wherein if the base part invoice price is greater than the product, then the part invoice price is the product; and
wherein if the base part invoice price is less than or equal to the product, then the part invoice price is the base part invoice price.

61. The method of claim 60, wherein the multiplier is two.

62. The apparatus of claim 48, wherein the software further configures the processor to display the part invoice price on the display.

63. An information carrier medium that communicates software to a computer, wherein the software when executed effects a part sourcing method that comprises:
specifying a generic part description for a part;
mapping the generic part description to one or more specific part descriptions across a plurality of vendors; and
generating a list of the one or more specific part descriptions.

64. The information carrier medium of claim 63, wherein the part sourcing method further comprises selecting a desired part from the list of the one or more specific part descriptions.

65. The information carrier medium of claim 63, wherein the part sourcing method further comprises filtering the list of the one or more specific part descriptions to generate a revised specific part list, wherein the step of filtering determines whether to exclude one or more specific part descriptions based on one or more specified criteria.

66. The information carrier medium of claim 65, wherein the specified criteria comprises vendor name, part brand, part number, part manufacturer, or combinations thereof.

67. The information carrier medium of claim 65, wherein the part sourcing method further comprises determining an availability for each specific part description on the revised specific part list.

68. The information carrier medium of claim 65, wherein the availability of each specific part description on the revised specific part list is determined by querying the vendor of each specific part description on the revised specific part list.

69. The information carrier medium of claim 65, wherein the part sourcing method further comprises selecting a desired part from the revised specific part list.

70. The information carrier medium of claim 69, wherein the part sourcing method further comprises electronically ordering the desired part.

71. An information carrier medium that communicates software to a computer, wherein the software when executed effects a part pricing method that comprises:
generating a list of one or more specific part descriptions;
filtering the one or more specific part descriptions to generate a revised specific part list, wherein the step of filtering determines whether to exclude one or more specific part descriptions based on one or more specified criteria;
selecting a desired part from the one or more specific part descriptions on the revised specific part list; and
determining a part invoice price for the desired part.

72. The information carrier medium of claim 71, wherein the specified criteria comprises vendor name, part brand, part number, part manufacturer, or combinations thereof.

73. The information carrier medium of claim 71, wherein the revised specific part list is different from the list of one or more specific part descriptions.

74. The information carrier medium of claim 71, wherein the list of one or more specific part descriptions is generated by:
specifying a generic part description for a part; and
mapping the generic part description to one or more specific part descriptions across a plurality of vendors.

75. The information carrier medium of claim 71, wherein the part sourcing method further comprises determining a list price for each specific part description on the revised specific part list.

76. The information carrier medium of claim 75, wherein the part sourcing method further comprises determining a highest list price for the one or more specific part descriptions on the revised specific part list.

77. The information carrier medium of claim 76, wherein the part sourcing method further comprises identifying the desired part list price.

78. The information carrier medium of claim 77, wherein the part sourcing method further comprises applying a part pricing matrix to the highest list price to determine a base part invoice price.

79. The information carrier medium of claim 78, wherein the part invoice price for the desired part is determined by:
comparing the base part invoice price to a maximum part price, wherein the maximum part price is a multiple of the desired part list price;
wherein if the base part invoice price is greater than the maximum part price, then the part invoice price equals the maximum part price; and
wherein if the base part invoice price is less than or equal to the maximum part price, then the part invoice price is the base part invoice price.

80. The information carrier medium of claim 79, wherein the multiple is two.
